(19) United States
(12) Patent Application Publication
(10) Pub. No.: US 2026/0329270 A1
(43) Pub. Date: Oct. 22, 2026

(54) SYSTEM

(71) Applicant: SoftBank Group Corp., Tokyo (JP)

(72) Inventor: Ryohei INOMATA, Tokyo (JP)

(73) Assignee: SoftBank Group Corp., Tokyo (JP)

(21) Appl. No.: 19/647,966

(22) Filed: Apr. 15, 2026

(30) Foreign Application Priority Data
Apr. 22, 2025 (JP) 2025-070605

(51) Int. Cl. G05B 23/02; G06F 16/2458; G06N 3/042; G06N 3/0442; G06N 3/0455; G06N 3/0464; G06N 3/0475

(52) U.S. Cl. CPC G05B 23/0281; G05B 23/024; G05B 23/0283; G06F 16/2458; G06N 3/042; G06N 3/0442; G06N 3/0455; G06N 3/0464; G06N 3/0475

(57) ABSTRACT

The present invention relates to a system targeting a plurality of physical devices such as servers and network devices, comprising a device information management unit, a log collection unit, a trend analysis and response unit, and the like, automatically collecting and analyzing operation logs and failure occurrence logs of each device using a generative AI, extracting a sign of failure occurrence and an abnormality sign with high accuracy, executing automatic contact and coordination to a maintenance vendor and a physical device replacement department when a failure occurs, and automatically feeding back a response result and a trend analysis result to an administrator and the like, thereby making it possible to significantly reduce a large amount of time and man-hours, and risks of human errors and response delays conventionally required, and dramatically improve availability and operational efficiency of an entire system.

### CROSS-REFERENCE TO RELATED APPLICATION

The present application claims priority to and incorporates by reference the entire contents of Japanese Patent Application No. 2025-070605 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

A problem to be solved by the present invention is to accurately grasp a sign of failure occurrence in physical devices such as servers and network devices, quickly and accurately acquire a failure log when a failure occurs, and automate contact and coordination with related departments such as a plurality of maintenance vendors and a physical device replacement department without relying on human labor, thereby significantly reducing a large amount of time and man-hours conventionally required, as well as risks of human errors and response delays, dramatically improving availability and operational efficiency of an entire system, and continuously analyzing a failure trend and an abnormal pattern for each device to be utilized for preventive maintenance and operational improvement.

### SUMMARY OF THE INVENTION

A means for solving the problem in the present invention is to configure a system comprising a device information management unit, a log collection unit, and a trend analysis and response unit, wherein the device information management unit centrally manages identification information, device types, log storage destination information, and operating state information of a plurality of physical devices such as servers and network devices, the log collection unit automatically collects operation logs and failure occurrence logs from each device managed by the device information management unit in real time or periodically, and the trend analysis and response unit analyzes the collected log data using a generative AI, extracts a failure occurrence trend and an abnormality sign for each device, executes an automatic contact process to a maintenance vendor and an automatic coordination process to a physical device replacement department based on failure details and related logs of a corresponding device when a failure occurs, and further automatically feeds back a response result and a trend analysis result to an administrator and an operation manager.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

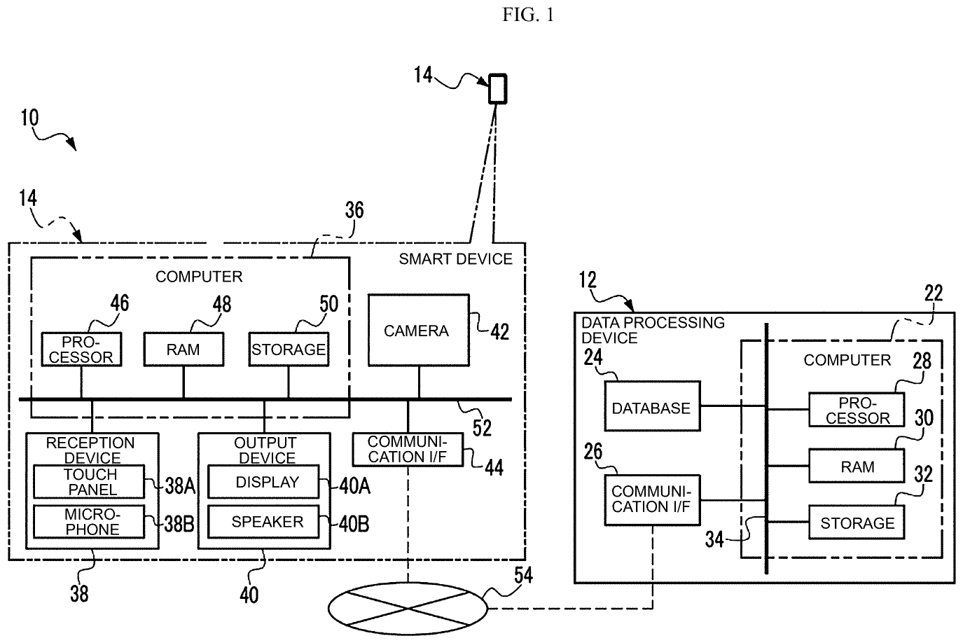

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

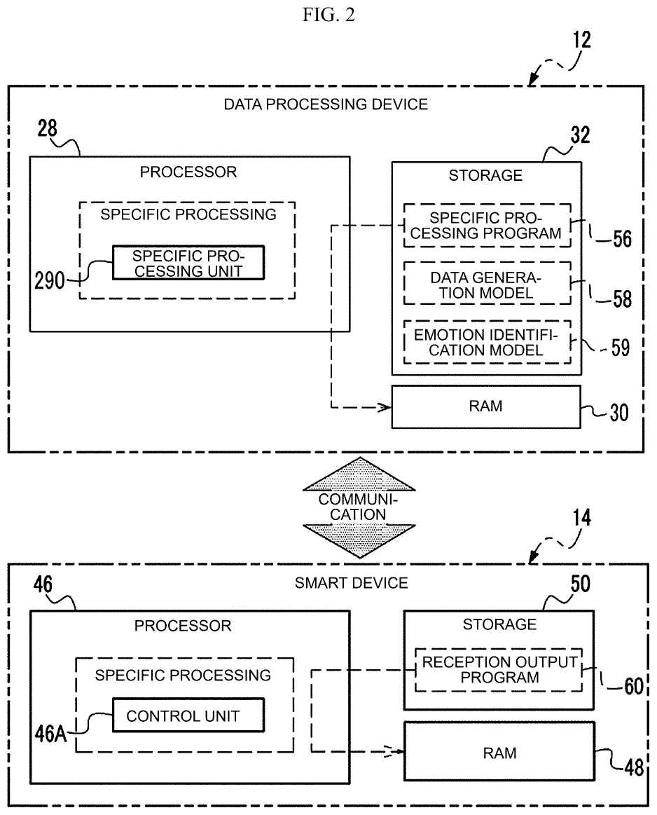

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### (Example 1)

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying out the Present Invention)

An embodiment for carrying out the present invention will be described extremely in detail and comprehensively, assuming a configuration consisting of a server and a terminal, while interweaving specific functions of each component, a method of utilizing a generative AI, role sharing between the server and the terminal, and various operation scenarios. Specifically, the present system causes a plurality of compute nodes to operate cooperatively in a distributed computing environment. The present system deploys a plurality of machine learning models including a large language model and a neural network for time-series analysis on a memory. The present system utilizes a remote procedure call and a message queuing protocol to perform high-speed data communication between the respective components. The present system causes the generative artificial intelligence to function not merely as a text generation tool but as an anomaly detection and autonomous control engine in a high-dimensional vector space. The present system receives time-series operation metrics collected from each device in a multidimensional tensor format as input data. The present system normalizes this multidimensional tensor and then inputs it to a transformer model equipped with a self-attention mechanism. The present system outputs a floating-point score indicating a future failure probability of each device and structured label data indicating a root cause of an abnormality as output data. When this output score exceeds a preset threshold, the present system immediately triggers a subsequent automatic recovery process and resource reallocation process. By executing such arithmetic processing in an unconventional high-dimensional space, the present system early captures a minute abnormality sign that cannot be discovered by human visual monitoring or conventional static rule-based threshold determination. By this early capture, the present system exhibits a technical effect of dramatically reducing downtime of the entire system and improving utilization efficiency of computing resources. The present system provides extremely high usefulness in specific application fields such as infrastructure management of a data center, preventive maintenance of a large-scale manufacturing line, and autonomous monitoring of a wide-area traffic control network.

First, the entire system implements a device information management unit, a log collection unit, a trend analysis and response unit, a notification and coordination unit, a database unit, and an API linkage unit on a server side, and implements a user interface unit, a notification receiving unit, and an instruction input unit used by an administrator and an operation manager on a terminal side. The server side cooperates with a plurality of physical devices (for example, a rack-mount server, a blade server, a network switch, a router, a firewall, a storage device, a UPS device, an IoT sensor node, an industrial controller, a surveillance camera, a medical device, a traffic infrastructure device, etc. in a data center) via a network, and collects and manages information from each device. Specifically, the present system adopts a client-server architecture and deploys each processing unit as an independent microservice on a container environment. The present system connects each unit on the server side with a high-speed internal virtual network. The present system represents static attributes and dynamic states of each physical device as nodes and edges on a graph database in the device information management unit. The present system receives millions of log events per second from tens of thousands of physical devices without loss using asynchronous IO processing in the log collection unit. The present system drives a large-scale neural network using a parallel computing cluster using graphics processing units in the trend analysis and response unit. The present system uses time-series array data obtained by sampling numerical vectors such as a CPU usage rate, a memory consumption amount, and a network traffic amount collected from each device at one-minute intervals as input data to the trend analysis and response unit. The present system cuts out this time-series array data by a sliding window method and inputs it to a long short-term memory network. The present system outputs a continuous value score from 0 to 1 indicating a probability that a specific failure will occur in the next 10 minutes as output data from the trend analysis and response unit. The present system passes this output score to the subsequent notification and coordination unit, and executes an automatic failover process when the score exceeds 0.8. With such a configuration, the present system not only collects information but also maps a huge amount of stream data to a high-dimensional space in real time and extracts a potential failure pattern. By this process, the present system brings about a technical effect of dramatically improving fault tolerance of the entire system and suppressing wasteful consumption of a communication band. The present system is applied to use cases such as integrated monitoring of tens of thousands of sensor groups in a smart factory and autonomous operation management of a wide-area distributed cloud infrastructure.

The device information management unit operates on the server and centrally manages identification information (for example, a device ID, an installation location, administrator information, a serial number, a firmware version, an installation date, a warranty period, and maintenance contract information), a device type (for example, a server, a network device, a storage device, a sensor, an actuator, a control device, etc.), log storage destination information (for example, a local storage, a cloud storage, an external log server, and a distributed file system), and operating state information (for example, normal, warning, failure, under maintenance, rebooting, shutting down, updating, etc.) of each physical device in a database. For example, device information can be hierarchically managed in units of racks in a data center, and information on virtual machines and containers in a virtualization environment can be similarly managed. Furthermore, a configuration change history of a device, a past failure response history, a history of replacement parts, contact information of a maintenance vendor, and the like are also recorded in detail. Specifically, the present device information management unit adopts a hybrid data store combining a relational database and an in-memory key-value store. The present device information management unit represents attribute information of each physical device as a multidimensional embedding vector. The present device information management unit executes representation learning using an autoencoder to generate this embedding vector. The present device information management unit uses a high-dimensional sparse vector obtained by one-hot encoding text attribute information and categorical data of a device as input data. The present device information management unit inputs this sparse vector to a multilayer perceptron to perform dimensional compression. The present device information management unit outputs a 256-dimensional dense floating-point vector capturing features of each device as output data. The present device information management unit utilizes this output vector as an input for a subsequent clustering process and similar failure search process. The present device information management unit holds a physical and logical connection relationship between devices on a memory as an adjacency matrix. The present device information management unit dynamically calculates the strength of a dependency relationship between devices from this adjacency matrix using a graph convolutional network. By adopting such a data structure and algorithm, the present device information management unit quantitatively evaluates a hidden correlation between complexly intertwined devices, which was impossible with conventional hierarchical directory management. By this quantitative evaluation, the present device information management unit exhibits a technical effect of instantly identifying an influence range that a configuration change of a certain device exerts on other devices and significantly improving a search speed of the database. The present device information management unit is extremely effective in use cases such as configuration management of a large-scale container orchestration environment where a configuration is frequently changed, and integrated asset management of an industrial robot group constituting a complex supply chain.

The log collection unit operates on the server and automatically collects operation logs and failure occurrence logs from each physical device in real time or periodically while referring to the database of the device information management unit. For example, logs can be acquired from servers, network devices, industrial devices, and IoT devices using various communication protocols and interfaces such as an SNMP protocol, Syslog, a REST API, agent software, SSH, WMI, Modbus, OPC UA, and MQTT. Furthermore, the log collection unit also has a function of organizing collected logs in chronological order and extracting detailed logs immediately before and after a failure occurrence and logs related to a specific event. For example, logs including various abnormality signs such as a CPU temperature abnormality, a disk error, and a memory leak of a server, a packet loss and a link down of a network device, an I/O error of a storage device, a rapid change in a sensor value, an abnormal stop of a control device, and an alarm occurrence of a medical device can be collected. In addition, log normalization, format conversion, unnecessary noise removal, automatic determination of importance, and the like are also performed. Specifically, the present log collection unit is constructed based on a distributed stream processing engine. The present log collection unit converts unstructured text logs received by various protocols into structured data in real time using a natural language processing model. The present log collection unit receives variable-length character string data transmitted from each device and a sensor payload in a binary format as input data. The present log collection unit executes preprocessing such as tokenization by a regular expression and stop word removal on these input data. The present log collection unit inputs the preprocessed token sequence to a pre-trained word embedding model. The present log collection unit outputs a fixed-length numerical vector expressing semantic features of a log message and an integer score from 0 to 10 indicating the importance of the log as output data. The present log collection unit transfers the output numerical vector and importance score as input features of an anomaly detection algorithm in the subsequent trend analysis and response unit. The present log collection unit immediately discards a noise log having an importance score less than a certain value on the memory, and omits writing to a storage. By executing such advanced filtering and vectorization processing on an edge side or at the forefront of collection, the present log collection unit significantly reduces a network communication band to a central server. By this process, the present log collection unit brings about a technical effect of improving an inference speed and accuracy of a subsequent machine learning model while suppressing consumption of a storage capacity. The present log collection unit is applied to use cases such as audit log monitoring of a financial trading system in which millions of events occur per second and real-time preprocessing of a huge amount of telemetry data transmitted from an autonomous driving vehicle.

The trend analysis and response unit operates on the server and analyzes a huge amount of collected log data using a generative AI. The generative AI uses, for example, a combination of a large language model, a time-series data analysis model, an anomaly detection model, a clustering model, a self-supervised learning model, a reinforcement learning model, and the like. Specifically, by learning a past failure occurrence pattern and a normal operation pattern and comparing them with current log data, a sign of failure occurrence and an abnormal pattern are extracted with high accuracy. For example, complex abnormalities that are difficult to detect by conventional threshold determination, such as when a memory usage rate of a server rapidly increases in a specific cycle, when errors are concentrated only on a specific port in a network device, when an I/O delay occurs only in a specific disk in a storage device, when a sensor value shows an abnormal trend, and when failures occur simultaneously and frequently in a plurality of devices, can be detected by multidimensional analysis by the generative AI. Furthermore, the generative AI can also perform estimation of a failure cause from log contents at the time of failure occurrence, similarity determination with past failure cases, automatic generation of a recommended countermeasure, estimation of an influence range of a failure, and the like. Specifically, the present trend analysis and response unit implements an advanced inference engine in which a plurality of neural networks are ensemble-coupled. The present trend analysis and response unit adopts a hybrid architecture combining a one-dimensional convolutional neural network and a self-attention mechanism for time-series data analysis. The present trend analysis and response unit receives a multidimensional tensor having a shape of 24 by 4 obtained by combining metrics such as a CPU usage rate, a memory consumption amount, disk IOPS, and a network delay for the past 24 hours as input data. The present trend analysis and response unit normalizes this multidimensional tensor and inputs it to the anomaly detection model. The present trend analysis and response unit outputs an array of floating-point values indicating a reconstruction error at each time step and a probability distribution from 0 to 1 indicating an occurrence probability of an abnormality as output data. When a peak value of this probability distribution exceeds a predetermined threshold, the present trend analysis and response unit inputs log data at that time to the large language model. The present trend analysis and response unit uses a text token sequence obtained by combining structured log data at the time of anomaly detection and a past similar failure report as a prompt as input data to the large language model. The present trend analysis and response unit outputs a structured object including a text string specifying a root cause of the failure and a list of recovery commands to be executed as output data from the large language model. The present trend analysis and response unit passes this output object to a subsequent automatic execution module to trigger automatic execution of a script. In learning of the model, the present trend analysis and response unit performs self-supervised learning using only normal data, and optimizes weights using a mean square error as a loss function. By using such an unconventional multi-stage inference method, the present trend analysis and response unit mathematically specifies a minute correlation abnormality among a plurality of devices that cannot be discovered by a single metric. By this process, the present trend analysis and response unit exhibits a technical effect of dramatically reducing a false positive rate and shortening a lead time for failure response to the utmost limit. The present trend analysis and response unit exhibits tremendous power in use cases such as back-end monitoring of a large-scale e-commerce site adopting a complex microservice architecture and integrated process control of a chemical plant spanning a plurality of plants.

In addition, based on an analysis result by the generative AI, the trend analysis and response unit automatically extracts failure details and related logs of a corresponding device when a failure occurs, and executes an automatic contact process to a maintenance vendor via the notification and coordination unit. For example, a device ID at the time of failure occurrence, failure details, a failure occurrence time, related logs, a past failure history, an estimated cause, a recommended countermeasure, and the like can be immediately notified to the maintenance vendor through API linkage, email transmission, automatic incident registration to a dedicated management system, automatic notification by a chatbot, automatic voice call transmission, and the like. Furthermore, as an automatic coordination process to a physical device replacement department, it is also possible to automatically generate an optimal replacement work schedule by referring to an inventory status of replacement parts, a schedule of a worker in charge, an access authority to a site, presence or absence of a work procedure manual, a preparation status of necessary tools and members, and the like, and simultaneously notify related departments. For example, even when a plurality of failures occur simultaneously, the generative AI can comprehensively determine the importance and influence range of the failures, the degree of influence on business, a past response history, a congestion status of the site, and the like, automatically determine a priority, and propose an optimal response order and resource allocation. Specifically, the present trend analysis and response unit solves an optimal resource allocation and scheduling problem using a reinforcement learning algorithm. The present trend analysis and response unit constructs an environment model based on a Markov decision process, and defines each failure event as a state space. The present trend analysis and response unit receives a multidimensional state vector including importance scores of a plurality of currently occurring failures, latitude and longitude coordinates indicating a current position of each maintenance person in charge, an integer value indicating the number of replacement parts in stock, and an expected required time for each work as input data. The present trend analysis and response unit inputs this state vector to a deep Q-network. The present trend analysis and response unit outputs an action vector corresponding to a maximum value of an action value function indicating which failure response each person in charge should be assigned to as output data. The present trend analysis and response unit converts this action vector into specific schedule data and transmits it to the subsequent notification and coordination unit. The present trend analysis and response unit sets minimization of downtime of the entire system and minimization of a moving distance of the person in charge as a reward function, and continuously updates weights of the model using a policy gradient method. By autonomously executing such advanced mathematical optimization processing inside a computer, the present trend analysis and response unit completely eliminates personalized and inefficient assignment work performed by a human dispatcher. By this process, the present trend analysis and response unit brings about a technical effect of mathematically minimizing a total time until recovery when a plurality of simultaneous failures occur and maximizing an operation rate of maintenance resources. The present trend analysis and response unit is applied to use cases such as base station maintenance work of a telecommunications carrier deployed on a nationwide scale and optimization of panel replacement work in a mega solar power plant having a vast site.

Furthermore, the trend analysis and response unit automatically feeds back a response result and a trend analysis result to an administrator and an operation manager. For example, a failure occurrence status, a response progress status, a trend analysis report, a recommendation for preventive maintenance, an estimation basis of a failure cause, a comparison with a past similar failure, a future risk prediction, and the like can be displayed on a dashboard in real time, or a report can be periodically distributed by email or a chat tool. In addition, the generative AI can customize feedback contents based on a past response history and operation policy of the administrator, a skill level of a person in charge, and a site situation, and provide information optimized for each person in charge. For example, flexible information provision is possible, such as presenting detailed procedures and links to reference materials to an inexperienced person in charge, and briefly notifying only main points to a skilled person in charge. Specifically, the present trend analysis and response unit implements a personalization engine integrating a natural language generation model and a recommendation system. The present trend analysis and response unit holds profile information of each person in charge as a user embedding vector on a multidimensional vector space. The present trend analysis and response unit receives text data of a generated failure report, an action sequence indicating a past browsing history of the person in charge, and a categorical variable indicating a skill level of the person in charge as input data. The present trend analysis and response unit combines these input data and inputs them to a transformer-based encoder-decoder model. The present trend analysis and response unit outputs a text string reconstructed with a vocabulary and a level of detail tailored to a comprehension level of the person in charge, and an identifier list of related manuals to be displayed as output data. The present trend analysis and response unit transmits the output text and identifier list to a subsequent user interface unit, and utilizes them for generating dynamic contents. The present trend analysis and response unit collects a stay time and a click operation when the person in charge browses feedback information as implicit feedback, and dynamically updates the user embedding vector using a collaborative filtering algorithm. By executing such adaptive information generation processing, the present trend analysis and response unit reduces a human cognitive load due to information overload and shortens an access time to necessary technical information. By this process, the present trend analysis and response unit exhibits a technical effect of reducing an occurrence probability of a human error and improving processing efficiency of the entire system operation business. The present trend analysis and response unit is extremely effective in use cases such as business support of a global IT support center composed of multinational members and an aircraft maintenance manual presentation system requiring advanced specialized knowledge.

The notification and coordination unit operates on the server and centrally manages notification and coordination to various related parties such as a maintenance vendor, a physical device replacement department, an administrator terminal, and a field worker terminal. For example, when a failure occurs, automatic contact to a maintenance vendor, a work request to a replacement department, an alert notification to an administrator, a work instruction to a field worker, an escalation notification to a management layer, and the like are executed concurrently. Furthermore, notification contents and coordination contents are automatically optimized according to an analysis result by the generative AI and a site situation. For example, flexible operation according to an operation policy is possible, such as immediately notifying only a highly urgent failure at night or on a holiday, and notifying all failures in detail during normal times. Specifically, the present notification and coordination unit adopts an event-driven message routing architecture and realizes asynchronous communication using a publish-subscribe model. The present notification and coordination unit holds a routing table for dynamically managing endpoint information of each notification destination on a memory. The present notification and coordination unit receives an importance score of a failure output from the trend analysis and response unit, node graph data indicating an influence range, and a timestamp of a current time as input data. The present notification and coordination unit inputs these input data to a decision tree-based classification algorithm. The present notification and coordination unit outputs a list of destinations to be notified, a flag indicating an optimal communication protocol for each destination, and a parameter of a transmission delay time as output data. Based on this output data, the present notification and coordination unit simultaneously transmits payloads to a plurality of external APIs using multi-thread processing. The present notification and coordination unit executes an automatic retry process using an exponential backoff algorithm when transmission fails. By executing such advanced routing and traffic control processing inside a computer, the present notification and coordination unit guarantees reliable message arrival while preventing network congestion. By this process, the present notification and coordination unit brings about a technical effect of minimizing a communication delay in an emergency and improving response performance of the entire system. The present notification and coordination unit is applied to mission-critical use cases such as an emergency contact network system of a local government at the time of a large-scale disaster and an immediate alert distribution system at the time of fraudulent transaction detection in a financial institution.

The database unit operates on the server and centrally manages all data such as device information, log data, a failure history, a response history, a trend analysis result, and a notification and coordination history. For example, all details from failure occurrence to recovery can be recorded in chronological order and utilized for later analysis, audit, and operation improvement. Furthermore, the database unit is also utilized as learning data for the generative AI, and contributes to continuous accuracy improvement and discovery of a new abnormal pattern. Specifically, the present database unit adopts a data lakehouse architecture integrating a distributed relational database for structured data, a distributed object storage for unstructured data, and an in-memory vector database for high-speed search. The present database unit compresses and stores time-series data using a column-oriented storage format with a timestamp as a primary key. The present database unit receives a log record asynchronously transmitted from each processing unit and a high-dimensional embedding vector generated by a machine learning model as input data. The present database unit executes deduplication processing using a Bloom filter and automatic cast processing of a data type on these input data. The present database unit collectively outputs a learning dataset matching a specified period and condition in a tensor format to a retraining pipeline of the machine learning model as output data. The present database unit constructs a hierarchical navigable small world graph, which is an approximate nearest neighbor search algorithm, in the vector database, and enables searching for a similar vector from among tens of millions of past failure vectors in milliseconds. By adopting such a complex data management method and an advanced index structure, the present database unit eliminates an IO bottleneck of writing and reading for petabyte-class data. By this process, the present database unit exhibits a technical effect of speeding up a learning cycle of the machine learning model and supporting continuous evolution of the system. The present database unit becomes an indispensable component in use cases such as an accumulation and search infrastructure for a huge amount of driving data collected from an autonomous driving vehicle group and an integrated management system for electronic medical records and medical images in a medical institution.

The API linkage unit operates on the server and realizes linkage with an external system, a management system manufactured by another company, a cloud service, a mobile application, a chatbot, a voice assistant, and the like. For example, it is possible to acquire an inventory status of replacement parts in real time by linking with an external inventory management system, automatically coordinate a schedule of a worker in charge by linking with an external work management system, and automatically evaluate a security risk at the time of failure occurrence by linking with an external security monitoring system. Specifically, the present API linkage unit functions as an API gateway that mediates communication between microservices, and includes a reverse proxy, a load balancer, and an authentication and authorization module. The present API linkage unit executes secure token-based authentication using an open authentication protocol in communication with an external system. The present API linkage unit receives a standardized data acquisition request issued from an internal system and a webhook payload push-transmitted from an external system as input data. The present API linkage unit executes schema verification processing and payload encryption/decryption processing on these input data. The present API linkage unit outputs response data whose data format is converted according to specifications of the external system as output data. The present API linkage unit routes this output data to each internal processing unit, and triggers execution of subsequent business logic. The present API linkage unit constantly monitors communication latency and an error rate, and applies a circuit breaker pattern to prevent a failure of the external system from spreading to the internal system. By autonomously executing such advanced traffic control and protocol conversion processing inside a computer, the present API linkage unit ensures interoperability between systems in a heterogeneous environment. By this process, the present API linkage unit brings about a technical effect of reducing development man-hours required for system integration and improving stability and security of linkage processing with an external service. The present API linkage unit is applied to use cases such as integrated management of a multi-cloud environment spanning a plurality of cloud providers and communication control of a smart home hub linked with various third-party applications.

On the terminal side, a user interface unit, a notification receiving unit, and an instruction input unit used by an administrator and an operation manager are implemented so that information provided from the server side can be viewed and operated in real time. For example, it is possible to immediately receive a failure occurrence alert on a dashboard screen on the terminal, check a response status and a trend analysis report, and send an additional instruction and comment to the server side as necessary. Furthermore, it is also possible to inquire about a detailed explanation of an analysis result by the generative AI and comparison information with past failure cases from the terminal side. For example, an on-site worker can proceed with work while referring to a work manual and a failure response history on a tablet terminal, the administrator can immediately grasp a failure occurrence status on a smartphone, and management can comprehensively check an overall operation status on a laptop computer. Specifically, the user interface unit on the terminal side adopts a single-page application architecture and performs bidirectional real-time data synchronization with the server using WebSocket communication. The user interface unit constructs a virtual document object model on a memory on the client side, and executes differential rendering according to a state change at high speed. The user interface unit receives, as input data, coordinate data of a failure, a numerical value indicating an importance level, and a time-series metrics array push-distributed from the server side. The user interface unit inputs these input data to a graphics library on the client side, and draws them as a three-dimensional topology map or a dynamic line graph. The user interface unit detects, as output data, a user's tap operation or swipe operation, converts those operation events into a structured command object, and sends it to the server side. The user interface unit causes the instruction input unit on the server side to interpret this command object, and triggers re-inference of a machine learning model or restart processing of a device. By combining such advanced drawing processing and asynchronous communication on the client side, the user interface unit minimizes the influence of network delay and provides a smooth operation experience without delay to the user. By this processing, the user interface unit exhibits a technical effect of reducing a rendering load on the server side and dramatically increasing the number of possible simultaneous connections of the entire system. The user interface unit is extremely effective in use cases such as a monitoring terminal in a financial dealing room where a decision in seconds is required, and a tablet terminal for remote control of construction machinery used in a harsh site environment.

As described above, in the embodiment of the present invention, the device information management unit, the log collection unit, the trend analysis and response unit, the notification and coordination unit, the database unit, and the API linkage unit are realized on the server side, and centralized management of device information, automatic collection and analysis of logs, extraction of a sign of failure occurrence, automatic response when a failure occurs, automatic coordination with related departments, and optimal feedback to the administrator are consistently automated using the generative AI. In addition, the user interface unit, the notification receiving unit, and the instruction input unit are realized on the terminal side so that the administrator and the operation manager can utilize the information on the server side in real time. For example, the system of the present invention can be applied in all fields such as a data center operation site, corporate IT infrastructure management, factory production equipment monitoring, medical equipment management in medical institutions, traffic infrastructure monitoring and control, remote monitoring of energy infrastructure, a building management system, and smart city infrastructure monitoring, and by utilizing the generative AI, it is possible to realize advanced sign detection, automatic response, and optimization that have been difficult to realize by conventional manual work or simple automation. Furthermore, since the generative AI continuously learns as operations are repeated and can improve failure detection accuracy and response optimization capability, it greatly contributes to long-term operation improvement, cost reduction, and availability improvement of the entire system. Specifically, the present system functions as an autonomous closed-loop control system integrating these respective processing units. The present system adopts a federated learning architecture that dynamically distributes arithmetic processing between an edge computing node and a cloud server. The present system periodically acquires, as input data, a global state vector of thousands of dimensions indicating an operating status of the entire system. The present system inputs this global state vector as an environmental state of a deep reinforcement learning model. The present system outputs, as output data, a continuous value vector indicating a parameter tuning value of the entire system and an update amount of a hyperparameter of the model. The present system finely adjusts a weight of each operating neural network online using this output vector. The present system defines a weighted sum of downtime and power consumption of the entire system as a loss function, and executes a gradient descent method so as to minimize this. By implementing such a self-optimization mechanism inside a computer, the present system continues to adaptively update the model even against secular changes in the environment and unknown cyber attacks. By this processing, the present system brings about a technical effect of permanently improving inference accuracy of the system without human intervention and dramatically reducing a life cycle cost of computational resources. The present system demonstrates its true value in use cases requiring ultimate reliability, such as autonomous operation of an unmanned fully automated data center, and an autonomous attitude control and abnormality recovery system for a satellite constellation in outer space.

### (System Configuration)

The system according to the present embodiment includes a device information management unit, a log collection unit, a trend analysis and response unit, a notification and coordination unit, a database unit, an API linkage unit, a user interface unit, a notification receiving unit, and an instruction input unit. The device information management unit centrally manages identification information, an installation location, administrator information, a serial number, a firmware version, an installation date, a warranty period, maintenance contract information, a configuration change history, a failure response history, a replacement part history, maintenance vendor contact information, and the like of various physical devices such as a rack-mount server, a blade server, a network switch, a router, a firewall, a storage device, a UPS device, an IoT sensor node, an industrial controller, a surveillance camera, a medical device, and a traffic infrastructure device in a data center. For example, information on virtual machines and containers in a virtualized environment can also be managed, and device information can be hierarchically managed in units of racks in the data center, or devices can be grouped and managed for each production line in a factory. Furthermore, an installation location of a medical device and information on a doctor in charge in a medical institution, and installation point information of a signal control device and a surveillance camera in a traffic infrastructure are also recorded in detail. Specifically, the present system deploys these components as a microservice architecture on a container orchestration platform, and controls communication between each service using a service mesh technology. The device information management unit constructs an ontology model based on a semantic web technology in order to integrally manage physical and logical asset information. The device information management unit receives, as input data, a list of MAC addresses and IP addresses obtained from a network scanning tool, and attribute data extracted from a configuration management database. The device information management unit parses these input data using a natural language processing technology, and converts them into a triple format of a resource description framework. The device information management unit outputs, as output data, a data structure of a directed acyclic graph indicating a dependency relationship and a physical arrangement relationship between devices. The device information management unit caches this graph data in an in-memory database, and provides it as an input for a subsequent failure influence range analysis algorithm. By executing such advanced data modeling and graph processing, the device information management unit expresses an overall picture of a complex system configuration, which cannot be grasped by simple tabular data management, in a form that can be mechanically interpreted by a computer. By this processing, the device information management unit exhibits a technical effect of exponentially shortening a calculation time for an influence degree evaluation at the time of a configuration change and improving search efficiency of the database. The device information management unit is applied to use cases such as an integrated platform for a smart city where millions of IoT devices dynamically repeat connection and disconnection, and an infrastructure management system for a large-scale communication carrier having a complex network topology.

The log collection unit automatically collects operation logs and failure occurrence logs from each physical device in real time or periodically while referring to the database of the device information management unit. Specifically, logs are acquired from servers, network devices, industrial devices, and IoT devices using various communication protocols and interfaces such as an SNMP protocol, Syslog, a REST API, agent software, SSH, WMI, Modbus, OPC UA, and MQTT. For example, logs including various abnormality signs such as a CPU temperature abnormality, a disk error, and a memory leak of a server, a packet loss and a link down of a network device, an I/O error of a storage device, a rapid change in a sensor value, an abnormal stop of a control device, an alarm occurrence of a medical device, and a signal abnormality of a traffic infrastructure device are collected. In addition, log normalization, format conversion, unnecessary noise removal, automatic importance determination, and extraction of detailed logs immediately before and after a failure occurrence and logs related to a specific event are also performed. Specifically, the log collection unit causes a plurality of data ingestion nodes distributed and arranged in an edge computing environment to operate cooperatively. The log collection unit operates a lightweight stream processing engine in each node, and immediately processes received raw data on a memory. The log collection unit receives, as input data, an unstructured text log described in a different format and a binary-encoded sensor data stream. The log collection unit executes field extraction using regular expression matching, timestamp standardization, and missing value interpolation processing on these input data. The log collection unit inputs the extracted text field to a pre-trained word embedding model. The log collection unit outputs, as output data, a 512-dimensional dense numerical vector expressing a semantic feature of the log and a floating-point score indicating an abnormality degree. The log collection unit asynchronously transmits the output vector and score to a message queue of a central server. For a normal log having a score equal to or less than a predetermined threshold, the log collection unit suppresses consumption of a network bandwidth by batching it for a certain period on the edge side and then compressing and transmitting it. By executing such advanced preprocessing and vectorization on the edge side, the log collection unit significantly reduces a CPU load on the central server and improves a log processing throughput of the entire system. By this processing, the log collection unit brings about a technical effect of minimizing an inference latency of a subsequent machine learning model while preventing network congestion. The log collection unit is extremely effective in use cases such as real-time processing of telemetry data transmitted every second from tens of thousands of connected cars, and data collection from countless sensors in a large-scale factory.

The trend analysis and response unit analyzes a huge amount of collected log data using a generative AI. The generative AI uses a combination of a large language model, a time-series data analysis model, an anomaly detection model, a clustering model, a self-supervised learning model, a reinforcement learning model, and the like. For example, by learning a past failure occurrence pattern and a normal operation pattern and comparing them with current log data, a complex abnormality that is difficult to detect by conventional threshold determination, such as a case where a memory usage rate of a server rapidly increases in a specific cycle, a case where errors are concentrated only on a specific port in a network device, a case where an I/O delay occurs only in a specific disk in a storage device, a case where a sensor value shows an abnormal trend, and a case where failures occur simultaneously and frequently in a plurality of devices, is detected by multidimensional analysis. Furthermore, estimation of a failure cause from log contents when a failure occurs, similarity determination with past failure cases, automatic generation of a recommended countermeasure, and estimation of a failure influence range are also performed. For example, when alarms occur frequently in a medical device, a cause can be estimated from similar past cases and a response procedure can be automatically generated, or when an abnormal stop occurs in a control device of a factory, a cause can be identified based on related sensor values and an operation history, and an optimal countermeasure can be presented to an on-site worker. Specifically, the trend analysis and response unit implements a multimodal inference architecture in which a plurality of neural networks are connected in a pipeline shape. The trend analysis and response unit uses a model combining a variational autoencoder and a long short-term memory network for analysis of time-series data. The trend analysis and response unit receives, as input data, a multidimensional tensor combining a 512-dimensional log feature vector transmitted from the log collection unit and metrics for the past one hour. The trend analysis and response unit inputs this multidimensional tensor to the variational autoencoder, and calculates a mean vector and a variance vector which are parameters of a probability distribution in a latent space. The trend analysis and response unit outputs, as output data, an abnormality score based on a Kullback-Leibler divergence indicating how much the input data deviates from a normal distribution. When this abnormality score exceeds a threshold, the trend analysis and response unit formats a log text and metrics data at that time as a prompt for the large language model, and inputs them. The trend analysis and response unit outputs, as output data from the large language model, a structured object including a category label indicating a root cause of the failure, an ID list of affected devices, and a recovery script to be executed. The trend analysis and response unit passes this object to a subsequent automatic recovery module, and triggers a self-healing process of the system. By combining probabilistic inference in such a high-dimensional space and natural language generation, the trend analysis and response unit reproduces advanced context understanding and logical inference performed by a human expert on a computer. By this processing, the trend analysis and response unit exhibits a technical effect of dramatically improving detection accuracy for an unknown failure pattern and realizing complete automation of failure response. The trend analysis and response unit is applied to use cases such as autonomous operation monitoring of a microservice group having a complex dependency relationship, and predictive maintenance of a medical image diagnostic apparatus requiring advanced expert knowledge.

The notification and coordination unit centrally manages notification and coordination to various related parties such as a maintenance vendor, a physical device replacement department, an administrator terminal, and an on-site worker terminal. For example, when a failure occurs, an automatic contact to the maintenance vendor, a work request to the replacement department, an alert notification to the administrator, a work instruction to the on-site worker, an escalation notification to management, and the like are executed concurrently. Notification contents and coordination contents are automatically optimized according to an analysis result by the generative AI and an on-site situation. For example, flexible operation according to an operation policy is possible, such as immediately notifying only a highly urgent failure at night or on a holiday, and notifying all failures in detail during normal times. Furthermore, an optimal replacement work schedule can be automatically generated and simultaneously notified to related departments by referring to an inventory status of replacement parts, a schedule of a person in charge of work, an access authority to a site, presence or absence of a work manual, a preparation status of necessary tools and members, and the like. Specifically, the notification and coordination unit implements a dynamic resource allocation algorithm using a graph neural network. The notification and coordination unit constructs a knowledge graph on a memory, with each person in charge of work, replacement part, and failure occurrence device as a node, and their relationship as an edge. The notification and coordination unit receives, as input data, an importance score of a failure output from the trend analysis and response unit, a one-hot vector indicating a skill set of each person in charge, and an integer value indicating the number of parts in inventory. The notification and coordination unit inputs these input data to the graph neural network, and updates a feature representation of each node. The notification and coordination unit outputs, as output data, an optimal matching matrix indicating which person in charge should head to which device with which part. The notification and coordination unit converts this matching matrix into specific schedule data, and transmits a push notification to a mobile terminal of each person in charge. When generating a schedule, the notification and coordination unit uses a heuristic algorithm for solving a traveling salesman problem together to minimize a movement route of the person in charge. By combining such advanced graph calculation and optimization algorithm, the notification and coordination unit calculates an optimal schedule satisfying complex constraint conditions in milliseconds. By this processing, the notification and coordination unit brings about a technical effect of minimizing a lead time of maintenance work and maximizing an operation efficiency of human resources. The notification and coordination unit demonstrates tremendous power in use cases such as a maintenance personnel dispatch system for renewable energy power generation facilities distributed over a wide area, and an emergency repair response system for medical equipment in a large-scale hospital.

The database unit centrally manages all data such as device information, log data, a failure history, a response history, a trend analysis result, and a notification and coordination history. For example, all details from a failure occurrence to recovery can be recorded in chronological order and utilized for later analysis, audit, and operation improvement. Furthermore, the database unit is also utilized as learning data for the generative AI, and contributes to continuous accuracy improvement and discovery of a new abnormal pattern. For example, based on a past failure response history, a countermeasure when a similar failure occurs can be automatically proposed, or a device with a high failure occurrence frequency can be extracted and utilized for drafting a preventive maintenance plan. Specifically, the database unit adopts a hybrid storage architecture combining a database using a distributed hash table and a column-oriented data warehouse in order to process petabyte-class data at high speed. The database unit includes an in-database machine learning function that executes data preprocessing and feature engineering inside the database in order to enhance learning efficiency of a machine learning model. The database unit receives, as input data, an unstructured text, time-series metrics, and a high-dimensional embedding vector generated from each processing unit. The database unit automatically executes dimensional compression processing using principal component analysis and correction processing of imbalanced data using a synthetic minority over-sampling technique on these input data. The database unit outputs, as output data, a dataset in a tensor format optimized for re-learning of the machine learning model at a specified batch size. The database unit incorporates a vector search engine, and searches for the top 5 past failure cases closest to a newly input failure vector in a few milliseconds using cosine similarity calculation. By integrating such advanced data processing functions and search algorithms into a storage layer, the database unit eliminates an overhead of data transfer via a network. By this processing, the database unit exhibits a technical effect of dramatically speeding up a learning pipeline of the machine learning model and improving a data processing throughput of the entire system. The database unit is applied to use cases such as a preventive maintenance system for an aircraft that accumulates and analyzes a huge amount of flight data, and a back-end infrastructure of a large-scale web service that analyzes behavior logs of millions of users in real time.

The API linkage unit realizes linkage with an external system, a third-party management system, a cloud service, a mobile application, a chatbot, a voice assistant, and the like. For example, it is possible to acquire an inventory status of replacement parts in real time by linking with an external inventory management system, automatically coordinate a schedule of a person in charge of work by linking with an external work management system, and automatically evaluate a security risk when a failure occurs by linking with an external security monitoring system. Furthermore, it is also possible to realize more advanced analysis, multilingual support, image analysis, and the like by linking with an external cloud AI service. Specifically, the API linkage unit functions as an enterprise service bus based on a service-oriented architecture, and dynamically executes protocol conversion, message routing, and data format conversion. When linking with an external cloud AI service, the API linkage unit uses a high-speed and low-latency binary communication protocol. The API linkage unit receives, as input data, an image tensor with a resolution of 1920 by 1080 acquired from an on-site surveillance camera, and voice waveform data input from a voice assistant. The API linkage unit transmits these input data to an endpoint of an external image recognition model or voice recognition model. The API linkage unit receives, as output data, a response including coordinate data of a bounding box indicating an abnormal part in an image, and character string data obtained by converting voice into text. The API linkage unit converts this received response data into an internal data structure processable by the internal trend analysis and response unit, and publishes it to a message queue. When a communication error or a timeout occurs, the API linkage unit applies a circuit breaker pattern to temporarily block a request to an external system, and executes fallback processing. By autonomously executing such advanced communication control and data conversion processing inside a computer, the API linkage unit prevents a failure chain of the entire system due to dependence on an external service. By this processing, the API linkage unit brings about a technical effect of seamlessly integrating capabilities of the latest external AI model into an internal system while enhancing fault tolerance of the system. The API linkage unit is indispensable in use cases such as an automatic control system for a huge warehouse linked with a plurality of third-party logistics systems, and a smart agriculture platform that integrates and analyzes various external data sources.

The user interface unit operates on a terminal used by an administrator and an operation manager, and enables information provided from the server side to be viewed and operated in real time. For example, it is possible to immediately receive a failure occurrence alert on a dashboard screen on the terminal, check a response status and a trend analysis report, and send an additional instruction and comment to the server side as necessary. An on-site worker can proceed with work while referring to a work manual and a failure response history on a tablet terminal, the administrator can immediately grasp a failure occurrence status on a smartphone, and management can comprehensively check an overall operation status on a laptop computer. Specifically, the user interface unit adopts a reactive programming paradigm, and dynamically updates a user screen by asynchronous processing of a data stream. The user interface unit executes advanced data visualization processing on a browser on the client side at a near-native speed using a WebAssembly technology. The user interface unit receives, as input data, a time-series metrics data array pushed from the server side via a WebSocket, and three-dimensional coordinate data indicating a failure occurrence location. The user interface unit processes these input data on a memory on the client side, and superimposes and draws them as a heat map on a three-dimensional digital twin model. The user interface unit captures, as output data, an event when a user clicks a specific node on a screen, generates a query object including an identifier of the node and a type of detailed information requested, and transmits it to the server side. While waiting for a response from the server to this query object, the user interface unit performs a predictive screen transition using a local cache to make a perceived waiting time zero. By combining such advanced arithmetic processing and cache control on the client side, the user interface unit completely eliminates a rendering load on the server side. By this processing, the user interface unit exhibits a technical effect of providing smooth operability without delay even to thousands of simultaneously connected users, and improving response performance of the entire system. The user interface unit is applied to use cases such as an industrial metaverse application that visualizes an internal structure of a complex plant in three dimensions, and a monitoring dashboard for a financial market where real-time performance is extremely important.

The notification receiving unit cooperates with the user interface unit to receive alerts, notifications, work instructions, reports, and the like from the server side in real time. For example, it is possible to immediately receive an emergency alert when a failure occurs, a response completion notification from a maintenance vendor, a work start contact from a replacement department, a breaking report of a trend analysis result by an AI, and the like, and display them to a person in charge in an easy-to-understand manner. Specifically, the present notification receiving unit implements a service worker operating in a background, and reliably receives a push notification from the server even in a state where an application is closed. The present notification receiving unit locally evaluates a priority of the received message, and presents it to a user at an appropriate interrupt level via a notification API of an operating system. The present notification receiving unit receives an encrypted payload transmitted from the server side as input data. The present notification receiving unit decrypts this payload using a local encryption key, and extracts an importance score, a title, a text, and an action button definition of the message. The present notification receiving unit forcibly draws a modal dialog accompanied by a vibration or a dedicated warning sound on a screen as output data when the importance score exceeds a predetermined threshold. When the user taps the action button, the present notification receiving unit generates callback data indicating an operation result thereof, and asynchronously transmits the callback data to the server side. In an environment where a network connection is unstable, the present notification receiving unit temporarily stores the received notification in a local indexed database, and automatically executes a synchronization process when the connection is recovered. The present notification receiving unit guarantees reliable transmission of an important alert by autonomously executing such advanced message management and offline response processing on a client terminal. By this processing, the present notification receiving unit brings about a technical effect of constructing a robust notification system independent of a communication environment and preventing a response delay in an emergency. The present notification receiving unit is extremely effective in use cases such as a mobile application for maintenance personnel working in a basement or a factory where radio waves are hard to reach, and a mission-critical information terminal for emergency personnel active at a disaster site.

The instruction input unit provides a function for an administrator or an operation manager to transmit an additional instruction or comment, a report on a site situation, a work completion report, approval/rejection of a failure response, and the like to the server side. For example, when a site worker discovers a new abnormality during work, the information can be immediately input to the system to prompt an additional analysis by the AI or a re-notification to a related department. Specifically, the present instruction input unit receives input data via a graphical user interface deployed on a memory of a user terminal. The present instruction input unit transfers the input text data to a natural language processing module. The present natural language processing module divides the text data into word or subword units. The present natural language processing module converts the divided tokens into a multidimensional embedding vector. The present system supplies this embedding vector to an input layer of a large language model. The present large language model extracts a context of the site situation from the input vector group. The present large language model dynamically updates an existing failure response flow based on the extracted context information. The present system immediately push-notifies the updated response flow to a terminal of the related department. The present processing unit converts the input work completion report into structured data. The present processing unit stores the structured data in a response history table of a relational database. The present system uses this response history data as a dataset for re-learning of a machine learning model next time. The present system forms a loop for feeding back a human judgment result to the system. The present system continuously improves inference accuracy of the machine learning model by this feedback loop. The present system converts an atypical text input from the site worker into a format interpretable by the system. The present system optimizes a cooperative operation between a human and a computer by this conversion processing. Unlike a conventional static rule-based system, the present system immediately adapts to a dynamic situation change. The present system significantly shortens a lead time until failure recovery by this adaptation capability. The present system exhibits an extremely high technical effect in various use cases requiring real-time performance, such as operation management of a data center and production line monitoring of a factory.

Specific examples of a prompt sentence to be read into the generative AI necessary for carrying out the present invention include: “Analyze the following server log data, collate it with past failure patterns to extract an abnormality sign and a sign, and output an estimated failure cause and a recommended countermeasure in detail in Japanese.”; “Analyze an abnormal communication pattern and an error occurrence trend chronologically from the following network device log, identify a location with a high risk of a serious failure, and list them in descending order of response priority.”; “Based on an I/O error log of a storage device, compare it with past similar failure cases, determine whether a sign of failure occurrence is seen, and propose a necessary preventive maintenance measure.”; “Analyze the following alarm history and sensor data of a medical device, detect whether there is a sign that a risk to patient safety increases, and generate an alert text to a person in charge at a site.”; and “Comprehensively analyze logs of a control device and a sensor group in a factory, predict a risk of an abnormal stop or a production line stop, and generate a response procedure for a site worker.” These prompt sentences may be automatically generated by the system, or may be customized and input by the administrator or the operation manager according to a situation. Specifically, the present system does not treat these prompt sentences as mere character strings, but holds them on a memory as a structured input template. The present system dynamically selects an optimal prompt template according to a device type of a target device and a current operating state. The present system embeds actual log data and sensor data extracted from a database into a variable portion of the selected template. The present system inputs the prompt sentence for which embedding processing has been completed to a tokenizer. The present tokenizer converts the prompt sentence into an integer token ID array. The present system configures this token ID array as an input tensor of the large language model. The present input tensor has a three-dimensional structure of, for example, a batch size, a sequence length, and an embedding dimension. The present large language model processes the input tensor using a plurality of transformer layers provided with a self-attention mechanism. The present large language model calculates a dependency relationship between respective tokens. The present large language model sequentially predicts a token having the highest probability of appearing next based on a calculation result. The present large language model generates the predicted token group as an output tensor. The present output tensor includes a probability distribution for each vocabulary. The present system selects a token having the highest probability from the output tensor, and decodes it into text data. The present system extracts information such as an estimated failure cause, a recommended countermeasure, and a response priority from the decoded text data using a regular expression or syntax analysis. The present system passes the extracted information as structured data to a subsequent notification module. The present system automatically generates a practical action plan from a log that is unstructured data by this series of processing. The present system reproduces an advanced analysis work performed by a human expert on a computer at high speed and accurately. By this automation, the present system eliminates personalization of operation management and dramatically improves availability of the entire system. The present system supports quick and accurate decision-making in a critical field related to human life or a large-scale economic loss, such as monitoring of a medical device and management of a control device in a factory.

In this way, the system according to the present embodiment enables early detection of a failure sign, quick response when a failure occurs, automatic coordination with a related department, and dramatic improvement in operation efficiency by each unit cooperating to correspond to various physical devices and operation sites, and realizing advanced trend analysis, automatic response, and optimization utilizing the generative AI. Specifically, the present system adopts a distributed computing architecture. The present system implements each function of data collection, data analysis, and notification processing as an independent microservice. The present system performs asynchronous communication using a message queuing protocol between the respective microservices. The present system prevents a load from concentrating on a specific module by this asynchronous communication. The present system ensures scalability and fault tolerance of the entire system. The present system arranges an inference engine having a generative artificial intelligence as a core on a dedicated compute cluster. The present inference engine executes a plurality of neural network models in parallel. The present inference engine integrates outputs of a time-series data analysis model and a natural language processing model. The present inference engine identifies a complex abnormal pattern undetectable by a single model by this integration processing. The present system inputs an output result of the inference engine to a rule-based control engine. The present control engine collates the inference result with a predefined operation policy. The present control engine determines an optimal response action based on a collation result. The present system transmits the determined action to a control interface of each physical device. The present system minimizes human intervention by this series of automation loops. The present system dramatically shortens a mean time to repair from failure occurrence to recovery. The present system realizes autonomous stable operation of a computer system itself, not limited to mere business efficiency improvement. The present system provides an essential infrastructure technology in a next-generation IoT environment where a huge number of devices are interconnected, such as infrastructure management of a smart city and autonomous operation of a large-scale cloud data center.

### (Implementation Steps)

Step 1: Centralized Registration and Management of Device Information At the time of system introduction or device addition, identification information, an installation location, administrator information, a serial number, a firmware version, an installation date, a warranty period, maintenance contract information, a configuration change history, a failure response history, a replacement part history, maintenance vendor contact information, and the like of various physical devices such as a server, a network device, a storage device, a UPS device, an IoT sensor node, an industrial controller, a monitoring camera, a medical device, and a traffic infrastructure device in a data center are centrally registered in the device information management unit, and recorded in a database including hierarchical group management and information on a virtualization environment. Specifically, the present device information management unit parses the input device information as structured data. The present device information management unit transmits the parsed data to a relational database management system. The present database management system divides attribute information of the device into a plurality of normalized tables and stores them. The present database management system sets a foreign key constraint between the respective tables. The present database management system ensures data consistency by this constraint. The present system models a physical and logical connection relationship between devices using a graph database. The present graph database defines each device as a node. The present graph database defines a connection and a dependency relationship between devices as an edge. The present system instantaneously identifies an influence range when a failure occurs in a specific device using a shortest path search algorithm by utilizing this graph structure. The present system records the configuration change history and the failure response history of the device in an append-only manner in a time-series database. The present system constructs an index for this time-series data. The present system searches past history data at high speed using the index. The present system periodically polls and updates mapping information between a virtual machine and a physical host in a virtualization environment. The present system follows a topology change accompanying migration of the virtual machine by this dynamic mapping information. The present system maintains a response time of a search query in milliseconds even in an environment where tens of thousands of devices exist by these advanced data management methods. The present system realizes elimination of a data silo by centralized management of information. The present system constructs a foundation for providing high-quality and comprehensive learning data to a subsequent machine learning model. The present system brings about extremely high operation efficiency in network management of a large-scale communication carrier, IT asset management of a global company deploying multiple bases, and the like.
Step 2: Automatic Collection and Normalization of Log Data The log collection unit automatically collects operation logs and failure occurrence logs from each physical device in real time or periodically using various communication protocols and interfaces such as SNMP, Syslog, a REST API, agent software, SSH, WMI, Modbus, OPC UA, and MQTT, and also performs log normalization, format conversion, unnecessary noise removal, automatic importance determination, and extraction of detailed logs immediately before and after a failure occurrence and logs related to a specific event. For example, logs including various abnormality signs such as a CPU temperature abnormality and a disk error of a server, a packet loss of a network device, an I/O error of a storage device, a rapid change in a sensor value, and an alarm occurrence of a medical device are collected. Specifically, the present log collection unit executes a plurality of protocol handlers as parallel threads. The present log collection unit receives raw log data asynchronously transmitted from each physical device. The present log collection unit temporarily buffers the received raw log data in an in-memory message queue. The present system prevents data loss due to a sudden log spike by this buffering. The present system sequentially extracts log data from the message queue and transfers it to a normalization engine. The present normalization engine extracts fields such as a timestamp, an importance level, an event ID, and a message text from unstructured text using a predefined regular expression pattern. The present normalization engine unifies the extracted timestamp to Coordinated Universal Time. The present normalization engine corrects a time lag between different devices. The present system applies an outlier detection algorithm to the normalized log data. The present system filters statistically meaningless noise data. The present system converts the filtered clean log data into a numerical vector processable by a machine learning model. The present system converts, for example, a natural language message text into a fixed-length vector representation using a word embedding method. The present system performs standardization processing on a sensor value, which is numerical data, so as to have zero mean and unit variance. The present system persists the data for which these preprocessings have been completed in a distributed file system. The present system simultaneously transfers the data to a stream processing engine for real-time analysis. The present system processes a wide variety of log data generated from a heterogeneous environment at high speed in a unified format by this advanced data pipeline. The present system dramatically improves analysis accuracy by a subsequent artificial intelligence. The present system realizes real-time state monitoring in a mission-critical environment where a delay in milliseconds is not allowed, such as an accounting system of a financial institution and an electronic commerce platform.
Step 3: Trend Analysis and Anomaly Detection by Generative AI The trend analysis and response unit analyzes a huge amount of collected log data utilizing the generative AI, learns a past failure occurrence pattern and a normal operation pattern, and compares them with current log data, thereby detecting a complex abnormality difficult to detect by conventional threshold determination, such as a periodic rapid increase in a memory usage rate of a server, error concentration on a specific port of a network device, an I/O delay of a specific disk of a storage device, an abnormal trend of a sensor value, and simultaneous multiple failures in a plurality of devices, by multidimensional analysis. Specific examples of a prompt sentence to be read into the generative AI include: “Analyze the following server log data, collate it with past failure patterns to extract an abnormality sign and a sign, and output an estimated failure cause and a recommended countermeasure in detail in Japanese.”; and “Analyze an abnormal communication pattern and an error occurrence trend chronologically from the following network device log, identify a location with a high risk of a serious failure, and list them in descending order of response priority.” Specifically, the present trend analysis and response unit divides normalized time-series log data by a certain time window. The present trend analysis and response unit configures the divided data as a multidimensional input tensor. The present input tensor is, for example, a three-dimensional array of the number of time steps, the number of feature dimensions, and a batch size. The present system inputs this input tensor to a neural network model specialized for time-series analysis. The present neural network model includes a long short-term memory layer and a transformer encoder layer. The present model extracts a temporal dependency relationship and a correlation between features from the input tensor. The present model maps the extracted feature representation as a vector on a latent space. The present system calculates a Euclidean distance between this latent vector and a cluster center of a normal pattern learned during past normal operation. The present system outputs the calculated distance as an anomaly score. The present system determines that an abnormality has occurred when the anomaly score exceeds a dynamically set threshold. The present system extracts a data segment determined to be abnormal, and converts it into a prompt sentence in a text format. The present system inputs this prompt sentence to a large language model. The present large language model analyzes a context of the input prompt sentence. The present large language model searches for a similar event from a past failure case database. The present large language model outputs a probability distribution of an estimated failure cause based on a search result. The present large language model generates a recommended countermeasure for a cause having the highest probability as natural language text data. The present system parses this text data, and extracts an executable command group and a setting change parameter. The present system automates cause investigation and presentation of a specific solution in a human-understandable format, not limited to mere numerical anomaly detection, by this series of processing. The present system captures a minute sign undiscoverable by human intuition or a conventional rule base by using a complex calculation in a high-dimensional space. The present system exhibits a technical effect of reducing downtime to the utmost limit in preventive maintenance of a large-scale data center and production line monitoring of a manufacturing industry constituting a complex supply chain.
Step 4: Automatic Response and Related Department Coordination when Failure Occurs The trend analysis and response unit automatically extracts failure details and related logs of a corresponding device when a failure occurs based on an analysis result by the generative AI, and executes an automatic contact process to a maintenance vendor and an automatic coordination process to a physical device replacement department via the notification and coordination unit. For example, through API linkage, email transmission, automatic incident registration to a dedicated management system, automatic notification by a chatbot, automatic voice call transmission, and the like, a device ID, failure details, a failure occurrence time, related logs, a past failure history, an estimated cause, a recommended countermeasure, and the like when a failure occurs are immediately notified to the maintenance vendor, and an optimal replacement work schedule is automatically generated by also referring to an inventory status of replacement parts, a schedule of a person in charge of work, an access authority to a site, presence or absence of a work procedure manual, a preparation status of necessary tools and members, and the like, and simultaneously notified to related departments. Specific examples of a prompt sentence to be read into the generative AI include: “Automatically generate a notification text to a maintenance vendor and a work instruction text to a replacement department based on the following failure occurrence log and device information.”; and “Analyze related logs and a past response history when a failure occurs, and output an optimal response procedure and priority.” Specifically, the present trend analysis and response unit converts the recommended countermeasure output from the generative artificial intelligence into a structured action object. The present system inputs this action object to a rule engine. The present rule engine collates a parameter included in the action object with an operation policy held in the system. The present system directly calls a control application programming interface of a target device for an action permitted to be automatically executed. The present system autonomously executes, for example, restart of a problematic process and dynamic switching of a network route. The present system activates the notification and coordination unit when physical part replacement or human intervention is necessary. The present notification and coordination unit issues a query to an external inventory management system or personnel schedule system. The present notification and coordination unit acquires information such as the number of replacement parts in stock, a storage location, free time of a person in charge of work, and possessed skills. The present system executes a scheduling algorithm using the acquired information as a constraint condition. The present scheduling algorithm searches for an optimal work schedule satisfying the shortest recovery time and the minimum cost using, for example, a genetic algorithm or simulated annealing. The present system encodes the calculated optimal schedule into a payload in a JSON format. The present system transmits this payload to an incident management system of the maintenance vendor as an HTTP POST request. The present system simultaneously generates a detailed work instruction manual in natural language for the person in charge of work using the large language model. The present system push-notifies the generated work instruction manual to a mobile terminal of the person in charge via a chatbot. The present system minimizes a time lag from failure detection to start of recovery work by this advanced linkage processing. The present system completely substitutes for a coordination work performed by a human administrator by autonomously negotiating with a plurality of external systems. The present system realizes quick and reliable failure response in maintenance operation of a communication infrastructure distributed over a wide area and facility management of a medical institution required to operate 24 hours a day.
Step 5: Feedback of Response Result and Trend Analysis Result The trend analysis and response unit and the notification and coordination unit automatically feed back a response result and a trend analysis result to an administrator and an operation manager. Through the user interface unit and the notification receiving unit, a failure occurrence status, response progress, a trend analysis report, a recommendation for preventive maintenance, an estimation basis of a failure cause, comparison with a past similar failure, future risk prediction, and the like are displayed on a dashboard in real time, and a report is periodically distributed by email or a chat tool. Specific examples of a prompt sentence to be read into the generative AI include: “Generate a feedback report for an administrator based on the following failure response history and trend analysis result.”; and “Compare a past failure case with current response details, and output a proposal item for operation improvement.” Specifically, the present system aggregates various data including the response result and the trend analysis result on a memory of a backend server. The present backend server converts the aggregated data into a dataset in a JSON format drawable by the user interface unit of a frontend. The present backend server asynchronously and continuously streams and distributes this dataset to a client terminal using a WebSocket protocol. The user interface unit on the present client terminal parses the received dataset. The present user interface unit dynamically updates a document object model tree based on the parsed data. The present user interface unit renders a visual element such as a time-series line graph, a heat map, and a network topology diagram on a browser using a data visualization library. The present system displays a natural language feedback report generated using a large language model as text on a dedicated panel of the dashboard. The present system automatically adds an explanation of a technical term and a hyperlink to a past similar case in this report generation. The present system provides a function of drill-down displaying related detailed raw log data and trace information of an inference process when the administrator clicks a specific item in the report. The present system activates batch processing using a scheduler such as a cron job in periodic report distribution processing. The present batch processing aggregates data of a specified period, and generates a report file in a PDF format or an HTML format. The present system transmits the generated file to a specified mailing list using a simple mail transfer protocol. The present system visualizes an internal state of a complex system in a format intuitively understandable by a human by these advanced information presentation technologies. The present system significantly reduces a cognitive load on the operation manager, and supports quick and accurate decision-making. The present system realizes optimal information provision according to a role of a recipient, from a summary report for a management layer to a detailed technical report for a site engineer.
Step 6: Continuous learning and optimization during operation. A database unit centrally manages all data such as device information, log data, failure histories, response histories, trend analysis results, and notification and coordination histories, and a generative AI continuously learns these data, thereby improving failure detection accuracy and response optimization capability. For example, based on past failure response histories, a countermeasure when a similar failure occurs is automatically proposed, a device with a high failure occurrence frequency is extracted and utilized for drafting a preventive maintenance plan, and feedback contents are optimized according to a situation of an operation site and a skill of a person in charge. Specific examples of a prompt sentence to be read by the generative AI include “Analyze all the following failure histories and response results, and generate a learning data set for future failure prevention and operation improvement.” and “Automatically design an optimal response flow at the time of next occurrence based on past response patterns.” Specifically, the database unit periodically extracts accumulated various history data. The system formats the extracted data as a data set for retraining a machine learning model. The system executes online learning or mini-batch learning using this data set. The system updates weight parameters of a neural network using a gradient descent method. The system calculates a loss function such as a cross-entropy error in a learning process. The system performs backpropagation so that a value of the loss function is minimized. The system introduces an experience replay method in order to prevent catastrophic forgetting in which an important pattern learned in the past is forgotten. The system mixes past representative failure case data into a current learning batch at a certain rate. The system optimizes a countermeasure using a reinforcement learning algorithm. The system defines a state of the system as a state vector. The system defines an executable countermeasure as an action space. The system calculates a recovery time and stability of the system obtained as an execution result of the countermeasure as a reward function. The system learns an optimal policy that maximizes a cumulative reward. The system deploys parameters of a new model for which learning has been completed to a verification environment. The system evaluates inference accuracy of the new model using past test data. The system hot-swaps an inference engine in a production environment to the new model only when the accuracy of the new model exceeds that of an old model. The system autonomously evolves intelligence of the system by this continuous integration and continuous deployment pipeline. The system acquires an ability to dynamically adapt to a change in an operation environment and an unknown abnormal pattern. The system exhibits an extremely high technical effect of continuously improving availability while gradually reducing maintenance costs of the system in long-term operation.

### (Specific Use Case)

For example, when the system of the present invention is applied to operation management of a server group and a network device group in a data center, first, the device information management unit centrally manages identification information, an installation location, administrator information, a serial number, a firmware version, an installation date, a warranty period, maintenance contract information, a configuration change history, a failure response history, a replacement part history, maintenance vendor contact information, and the like of each server, network switch, router, firewall, storage device, UPS device, rack-unit power supply control device, surveillance camera, temperature/humidity sensor, air conditioning equipment, and the like. The log collection unit automatically collects operation logs, failure occurrence logs, temperature/humidity logs, power state logs, access logs, security event logs, and the like from each device in real time or periodically using various protocols such as SNMP, Syslog, REST API, agent software, SSH, WMI, Modbus, and MQTT, and performs log normalization, format conversion, noise removal, importance determination, and extraction of logs before and after a failure occurrence. Specifically, the system constructs a scalable data lake architecture in order to process petabyte-class data generated from tens of thousands of devices distributed and arranged in the data center. The device information management unit stores static and dynamic attribute information of each device in a key-value store type distributed database. The system responds to high-frequency read/write requests with low latency by this distributed database. The log collection unit utilizes a lightweight data collection agent operating on an edge computing node arranged in the vicinity of each device. The agent primarily processes raw log data output from the device on a local memory. The agent discards unnecessary debug messages using regular expression matching. The agent structures the remaining log data into a JSON format. The agent compresses the structured data using a data compression algorithm. The agent transmits the compressed data to a central log collection cluster via a secure encrypted communication channel. The log collection cluster distributedly stores the received data in a block unit in a Hadoop distributed file system or the like which is a distributed file system. The system executes an extraction, transformation, and loading process on the stored data. The system executes data cleansing such as timestamp synchronization, character code unification, and missing value interpolation at high speed using a parallel distributed processing framework. The system loads the cleansed data into a column-oriented database. The system dramatically improves an execution speed of an aggregation query and a search query for a specific log field by this column-oriented format. The system converts a huge amount of and diverse log data into a high-quality data set that can be efficiently processed by a machine learning model by these advanced data engineering methods. The system prevents information silos in the operation of the data center, and provides a robust foundation for grasping a state of the entire system comprehensively and in real time.

The trend analysis and response unit utilizes the generative AI to, for example, when a CPU temperature of a server continuously rises and an abnormal value of a fan rotation speed and a voltage fluctuation of a power supply device are simultaneously observed, integrally analyze these plurality of log data in chronological order, and compare them with a past failure occurrence pattern and a normal operation pattern, thereby extracting a sign such as an abnormality in a cooling system and deterioration of a power supply system with high accuracy. Furthermore, when a packet loss of a specific port increases in a network device and a link down event and an ARP error are simultaneously recorded, the generative AI associates and analyzes these complex abnormalities, estimates various risks such as a physical failure on a network route, a setting error, and a sign of an external attack, and proposes a countermeasure in descending order of priority. In a storage device, when an I/O delay and a retry error of a specific disk occur intermittently and a warning log of a RAID controller is simultaneously recorded, the generative AI estimates a progress degree and an influence range of a failure, and automatically presents a data loss risk and a recommended backup timing. Specifically, the trend analysis and response unit adopts a multimodal neural network architecture. The system inputs a time-series array of the CPU temperature and the fan rotation speed, which are numerical data, to a one-dimensional convolutional neural network, and extracts a local feature map. The system inputs a warning log and an error message, which are text data, to a word embedding layer, and converts them into a dense vector representation. The system combines feature vectors obtained from these different modalities using a cross-attention mechanism. The cross-attention mechanism calculates a hidden correlation between a fluctuation of the numerical data and an appearance pattern of the text log. The system inputs the combined feature vector to a fully connected layer. The fully connected layer outputs a probability distribution for a predefined failure category using a softmax function. The system calculates a specific score such as, for example, a probability of “physical failure of cooling fan” being 85 percent and a probability of “clogging of heat sink” being 12 percent. The system identifies the most likely failure cause based on this probability distribution. The system inputs the identified failure cause and a current system state vector to a reinforcement learning agent. The agent outputs an optimal action sequence that minimizes a future system downtime based on a Markov decision process. The system converts this action sequence into a countermeasure list in a natural language understandable by a human. The system detects a complex sign of failure occurrence, which is overlooked by simple threshold monitoring for a single metric, at an early stage by this advanced inference mechanism. The system triggers a preventive maintenance action before a failure becomes apparent and the system stops. The system brings about an extremely important technical improvement in complying with a service level agreement of the data center and ensuring continuity of a mission-critical service.

A notification and coordination unit immediately notifies the maintenance vendor of failure details of a corresponding device, a related log, a failure occurrence time, a past failure history, an estimated cause, a recommended countermeasure, and the like when a failure occurs based on an analysis result by the generative AI by API linkage, mail transmission, automatic incident registration to a dedicated management system, chatbot notification, or the like, and automatically generates and notifies an optimal replacement work schedule to the physical device replacement department by referring to an inventory status of replacement parts, a schedule of a person in charge of work, a site access authority, presence or absence of a work procedure manual, a preparation status of necessary tools and members, and the like. For example, flexible operation according to an operation policy is possible, such as immediately notifying only a failure with a high degree of urgency at night or on a holiday, and notifying all failures in detail during normal times. Specifically, the notification and coordination unit receives a failure information object output from an inference engine. The notification and coordination unit collates an importance score included in this object with a routing table by time zone set in the system. The system activates an emergency notification flow when a current time is in a night time zone and the importance score exceeds a predetermined threshold. The emergency notification flow performs automatic voice transmission using a VoIP protocol to a smartphone of a person in charge of maintenance. The system converts an outline of the failure into voice data using a voice synthesis engine, and plays it when a call is established. The system simultaneously transmits a POST request including a payload in a JSON format to a RESTful API of an incident management system of the maintenance vendor. The payload includes a MAC address and an IP address of the device, an error stack trace for the latest 5 minutes, and a probability distribution of the estimated cause calculated by the AI. The system activates a constraint satisfaction problem solver when it is determined that physical part replacement is necessary. The solver acquires data in real time from a part inventory database, a calendar system of the person in charge, and an entry/exit management system of the data center. The solver inputs these data as constraint conditions, and searches for an optimal schedule solution including a work start time, a person in charge to be assigned, and a necessary tool list. The system converts the searched schedule solution into data in an iCalendar format, and automatically registers it in groupware of related parties. The system dramatically shortens a time required for an initial response when a failure occurs from several tens of minutes to several seconds by this series of automated processes. The system completely eliminates human errors such as a contact omission and an arrangement mistake by a human operator. The system dramatically improves efficiency and certainty of an operation management process by a computer autonomously executing a complex coordination task among stakeholders.

A user interface unit and a notification receiving unit display a failure occurrence alert, a response status, a trend analysis report, a preventive maintenance recommendation, an estimation basis of a failure cause, a comparison with a past similar failure, a future risk prediction, and the like in real time on a terminal of the administrator or the operation manager, allowing a site worker to proceed with work while referring to a work procedure manual and a failure response history on a tablet terminal, the administrator to immediately grasp a failure occurrence status on a smartphone, and a management layer to comprehensively confirm an overall operation status on a notebook computer. Through an instruction input unit, when the site worker discovers a new abnormality, it is also possible to immediately input the information to the system and prompt additional analysis by the AI and re-notification to related departments. Specifically, the user interface unit is constructed by adopting a single page application architecture. The user interface unit establishes a WebSocket connection with a backend server, and maintains a bidirectional real-time communication channel. When a new failure alert or analysis result is generated in a backend, the system immediately push-transmits a message in a JSON format to a client terminal. A browser engine on the client terminal parses the received message and updates a virtual document object model. The system applies only a difference of this virtual document object model to an actual document object model, thereby minimizing a screen redrawing cost and providing a smooth user experience. The system dynamically generates an optimal layout for various devices having different screen sizes and resolutions, such as a tablet terminal, a smartphone, and a notebook computer, using a responsive web design technology. The system receives image data of an abnormal part photographed by the site worker using a camera function of the tablet terminal from the instruction input unit. The system Base64-encodes this image data and transmits it to the backend. The backend system inputs the received image data to an image recognition model using a convolutional neural network. The image recognition model detects physical damage and a wiring abnormality in an image, and outputs coordinates of a bounding box and a certainty score. The system integrates this image analysis result and report contents by text, and executes additional situation analysis using a large language model. The system immediately feeds back an updated analysis result and a new response procedure to the terminal of the site worker. The system incorporates tacit knowledge of a site into the system as digital data by this advanced human-machine interface. The system realizes interactive cooperative work between a human and an artificial intelligence, and optimizes a complex failure response process.

Specific examples of a prompt sentence to be read by the generative AI include “Analyze time-series log data of a plurality of devices such as the following servers, network devices, storage devices, UPS devices, and temperature/humidity sensors, extract an abnormality sign and a sign, and output an estimated failure cause and a recommended countermeasure in detail in Japanese.”, “Analyze an abnormal communication pattern and an error occurrence trend in chronological order from logs of the following network devices, identify a part having a high risk of a serious failure, and list them in descending order of response priority.”, “Determine whether a sign of failure occurrence is seen based on an I/O error log of a storage device and a warning log of a RAID controller, and propose a necessary preventive maintenance measure.”, “Automatically generate a notification text to a maintenance vendor and a work instruction text to a replacement department based on the following failure occurrence log and device information.”, and “Analyze all failure histories and response results, and generate a learning data set for future failure prevention and operation improvement.” Specifically, the system operates an automation module of prompt engineering when generating these prompt sentences. The module adopts a few-shot prompting method. The module arranges several pairs of inputs and outputs of past successful analysis cases at the beginning of a prompt. The system explicitly instructs an expected output format and a depth of inference to a large language model by adding this context information. The system applies a text summarization algorithm when a size of input log data exceeds a limit of a context window of the large language model. The system deletes an information event with low importance, extracts only a critical error message and sensor data indicating an abnormal value, and embeds them in the prompt. The system converts the constructed prompt character string into a token sequence using a subword tokenization algorithm such as byte pair encoding. The system inputs this token sequence to a transformer-based language model. The language model calculates a long-distance dependency relationship between tokens using a self-attention mechanism, and deeply understands a context. The language model outputs a classification label of a failure cause, a floating-point number indicating a certainty factor, and a response procedure manual structured in a markdown format as an inference result. The system parses the output markdown text, converts it into an HTML element, and passes it to the user interface unit. The system causes a general-purpose large language model to function as a highly accurate expert system specialized for a specific domain task by this series of prompt processing pipelines. The system saves a human the trouble of manually performing trial and error on a prompt, and always provides an optimized query to the model. The system maximizes a potential of the generative artificial intelligence by this technology, and provides a core inference capability toward complete automation of an operation management task.

In this way, the system of the present invention centrally manages information of a plurality of devices in various sites such as a data center, a factory, a medical institution, and a transportation infrastructure, realizes advanced trend analysis and automatic response by the generative AI, and enables early detection of a sign of failure, rapid response when a failure occurs, automatic coordination with related departments, and a dramatic improvement in operation efficiency. Specifically, the system adopts a hybrid architecture in which a cloud computing environment and an edge computing environment are seamlessly integrated. The system executes primary filtering of sensor data and real-time anomaly detection by a lightweight machine learning model in an edge node arranged at each site. The system dramatically reduces an amount of data transmitted to a cloud side and saves a network bandwidth by this edge processing. The system simultaneously executes advanced trend analysis and long-term prediction simulation using a deep learning model targeting a huge amount of data aggregated from a plurality of sites in a large-scale computing cluster on a cloud. The system periodically distributes and synchronizes weight parameters of the latest inference model updated on the cloud side to each edge node. The system achieves both local control requiring responsiveness in milliseconds and advanced decision-making based on global data by this distributed cooperative processing. The system includes an abstraction layer that absorbs a difference in communication protocols in a heterogeneous mixed environment. The system eliminates vendor lock-in and enables management of diverse devices with a unified interface. The system realizes cross-domain data correlation analysis, which was impossible with a conventional siloed management system, by fundamental improvement of these computer technologies. The system predicts a fatal motor failure that may occur several weeks later from a minute change in vibration data in a production line of a factory, for example, and automatically arranges planned part replacement. The system exhibits an outstanding technical effect of preventing an economic loss due to downtime and maximizing reliability and an operation rate of the entire industrial infrastructure.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying out the Present Invention)

An embodiment for carrying out the present invention will be described extremely specifically and comprehensively in detail, taking a factory robot field as an example.

The system according to the present embodiment targets various automated devices such as a welding robot, a painting robot, an assembly robot, a transfer robot, an inspection robot, a palletizing robot, and a collaborative robot in a factory, and peripheral devices thereof (a control panel, an end effector, various sensors, a transfer line, a vision system, a force sensor, a torque sensor, a temperature sensor, a vibration sensor, an image recognition camera, a barcode reader, an RFID reader, a PLC, an industrial PC, air conditioning equipment, a power supply device, a battery management device, a cooling fan, a lubrication device, a grease supply device, an air supply device, a nozzle cleaner, a filter, a lighting device, a workbench, a protective fence, an emergency stop device, an alarm lamp, a worker detection sensor, an access control device, etc.). For each device, identification information (a device ID, a serial number, an installation line number, an installation area, installation coordinates, an installation hierarchy, an installation rack number, an installation date, a person in charge of installation), administrator information (a person in charge ID, contact information, a maintenance contract destination, maintenance contract details, a maintenance deadline, a maintenance history), a serial number, a firmware version, a software version, an installation date, a warranty period, maintenance contract information, a configuration change history (a part replacement history, a software update history, a firmware update history, an installation location change history, a line configuration change history, a control logic change history), a failure response history (a failure occurrence date and time, failure details, a failure cause, a responder, response details, a response completion date and time, presence or absence of recurrence, a recurrence date and time, a recurrence cause, recurrence response details), a part replacement history (a replacement part name, a replacement date and time, a replacement reason, a person in charge of replacement, a post-replacement part ID, a pre-replacement part ID, a warranty period of a replacement part, maintenance contract information of a replacement part), maintenance department contact information (a maintenance company name, a person in charge name, a telephone number, a mail address, an emergency contact, a night contact), and a sensor data type (temperature, humidity, vibration, current, voltage, torque, force, pressure, flow rate, image, sound, light, color, position, speed, acceleration, distance, proximity, load, stress, strain, wear, remaining amount, concentration, foreign matter detection, abnormal noise detection, abnormal odor detection, electric leakage detection, water leakage detection, oil leakage detection, abnormal heat generation detection, abnormal vibration detection, abnormal sound detection, abnormal light detection, abnormal color detection, abnormal position detection, abnormal speed detection, abnormal acceleration detection, abnormal distance detection, abnormal proximity detection, abnormal load detection, abnormal stress detection, abnormal strain detection, abnormal wear detection, abnormal remaining amount detection, abnormal concentration detection, abnormal foreign matter detection, abnormal abnormal noise detection, abnormal abnormal odor detection, abnormal electric leakage detection, abnormal water leakage detection, abnormal oil leakage detection, abnormal heat generation detection, abnormal vibration detection, abnormal sound detection, abnormal light detection, abnormal color detection, abnormal position detection, abnormal speed detection, abnormal acceleration detection, abnormal distance detection, abnormal proximity detection, abnormal load detection, abnormal stress detection, abnormal strain detection, abnormal wear detection, abnormal remaining amount detection, abnormal concentration detection, abnormal foreign matter detection, abnormal abnormal noise detection, abnormal abnormal odor detection, abnormal electric leakage detection, abnormal water leakage detection, abnormal oil leakage detection, abnormal heat generation detection, abnormal vibration detection, abnormal sound detection, abnormal light detection, abnormal color detection, abnormal position detection, abnormal speed detection, abnormal acceleration detection, abnormal distance detection, abnormal proximity detection, abnormal load detection, abnormal stress detection, abnormal strain detection, abnormal wear detection, abnormal remaining amount detection, abnormal concentration detection, abnormal foreign matter detection, abnormal abnormal noise detection, abnormal abnormal odor detection, abnormal electric leakage detection, abnormal water leakage detection, abnormal oil leakage detection, abnormal heat generation detection, abnormal vibration detection, abnormal sound detection, abnormal light detection, abnormal color detection, abnormal position detection, abnormal speed detection, abnormal acceleration detection, abnormal distance detection, abnormal proximity detection, abnormal load detection, abnormal stress detection, abnormal strain detection, abnormal wear detection, abnormal remaining amount detection, abnormal concentration detection, abnormal foreign matter detection, abnormal abnormal noise detection, abnormal abnormal odor detection, abnormal electric leakage detection, abnormal water leakage detection, abnormal oil leakage detection, etc.) are centrally managed. Specifically, the system structures these huge and diverse device attribute information and sensor metadata using a graph database and expands them on a memory. The graph database defines each robot main body, peripheral device, and individual sensor as an independent node. The graph database defines a physical connection relationship, a power supply dependency relationship, and a topology of a communication network as an edge. The system holds static data such as a firmware version and a maintenance history in a key-value format as a property of each node. The system utilizes this graph structure to, for example, when a failure occurs in a specific power supply device, instantaneously identify all robots and sensor groups supplied with power from the power supply device using a breadth-first search algorithm. The system automatically issues a safe shutdown sequence to devices within the identified influence range. The system stores multidimensional physical quantity data acquired by each sensor in association with a corresponding tag of a time-series database. The system efficiently manages stream data sent in milliseconds from tens of thousands of sensors in association with a physical positional relationship and a logical dependency relationship of devices by this data modeling. The system enables advanced data search having a spatial and logical context, which is impossible with a simple list-format database. The system provides a base data structure for constructing a digital twin of a complex production line in a smart factory. The system dramatically shortens a time for identifying an influence range when a failure occurs and prevents occurrence of secondary damage by this technical improvement.

The log collection unit automatically collects operation logs, failure occurrence logs, sensor data, event logs, operation histories, worker logs, alarm histories, maintenance histories, part replacement histories, software update histories, firmware update histories, line configuration change histories, control logic change histories, abnormal events, alarm events, warning events, caution events, information events, operation events, work events, maintenance events, inspection events, cleaning events, replenishment events, replacement events, repair events, recovery events, restart events, stop events, start events, switching events, disconnection events, connection events, communication events, synchronous events, asynchronous events, batch events, real-time events, periodic events, aperiodic events, sudden events, steady events, unsteady events, abnormality detection events, abnormality cancellation events, abnormality recurrence events, abnormality unresolved events, abnormality resolved events, abnormality reporting events, abnormality unreported events, abnormality recurrence prevention events, abnormality recurrence prevention unexecuted events, abnormality recurrence prevention executed events, abnormality recurrence prevention completed events, abnormality recurrence prevention uncompleted events, abnormality recurrence prevention plan events, abnormality recurrence prevention plan unexecuted events, abnormality recurrence prevention plan executed events, abnormality recurrence prevention plan completed events, abnormality recurrence prevention plan uncompleted events, abnormality recurrence prevention plan reporting events, abnormality recurrence prevention plan unreported events, abnormality recurrence prevention plan reporting completed events, abnormality recurrence prevention plan reporting uncompleted events, and the like from each device in real time or periodically using various communication means such as SNMP, OPC UA, Modbus, EtherCAT, REST API, proprietary protocols, agent software, MQTT, FTP, via USB memory, wireless communication, short-range wireless communication, infrared communication, optical communication, satellite communication, and cloud linkage, and accumulates them in a database. For example, the log collection unit collects a motor temperature and a vibration value of a welding robot every minute, immediately collects a nozzle clogging event of a painting robot when it occurs, records a torque sensor value of an assembly robot for each work cycle, records a remaining battery level and a travel distance of a transfer robot every 10 minutes, and records an image recognition result and the number of defective product detections of an inspection robot for each inspection cycle. Furthermore, the log collection unit also performs log normalization, format conversion, noise removal, importance determination, extraction of logs before and after a failure occurrence, automatic marking of abnormal events, automatic classification of abnormal events, automatic prioritization of abnormal events, automatic association of abnormal events, automatic influence range estimation of abnormal events, automatic cause estimation of abnormal events, automatic countermeasure proposal of abnormal events, automatic notification of abnormal events, automatic reporting of abnormal events, automatic recording of abnormal events, automatic analysis of abnormal events, automatic learning of abnormal events, automatic optimization of abnormal events, and the like. Specifically, the present log collection unit implements a gateway module that performs protocol conversion between an industrial network protocol and an IT network protocol. The present gateway module converts, for example, periodic binary data from a fieldbus requiring real-time performance into a lightweight messaging protocol based on a publish-subscribe model. The present system transmits the converted data to a message broker. The present system executes a fast Fourier transform on high-frequency vibration sensor data on an edge device. The present system converts time-domain waveform data into frequency-domain spectrum data. By this conversion process, the present system extracts features of a specific frequency component caused by bearing wear or the like while significantly compressing a data size. The present system transmits only the extracted feature vector to a cloud server. The present system minimizes consumption of a network bandwidth. The present system applies an automatic classification algorithm using a natural language processing technology to a wide variety of event logs received on the cloud server side. The present system maps operation histories and maintenance events, which are unstructured texts, to predefined category labels. The present system assigns an index using a time stamp as a key to each event, and stores it in a time-series database. When an abnormal event is detected, the present system automatically extracts all related logs recorded for several minutes before and after an occurrence time of the event from the database. The present system summarizes the extracted log group as one context window, and generates tensor data to be input to a subsequent machine learning model. By this advanced data preprocessing pipeline, the present system extracts only valuable information from noisy raw data, and enables highly accurate inference by an artificial intelligence. The present system captures all events in a factory as digital data, and ensures complete traceability.

The trend analysis and response unit analyzes a huge amount of collected time-series data and event logs in multiple dimensions using a generative AI. For example, when a motor temperature of a welding robot rises more slowly than usual and a vibration value shows an increasing trend at the same time, the AI estimates this as a sign of grease deterioration of a reduction gear or bearing wear. When a minute fluctuation in application pressure and frequent occurrence of nozzle clogging events are simultaneously observed in a painting robot, the AI automatically generates a recommendation for nozzle cleaning or replacement. When an increase in variation of torque sensor values and an increase in tightening errors are detected in an assembly robot, the AI estimates wear of an end effector or an abnormality in a part supply system, and presents a countermeasure. When a decrease in remaining battery level and a shortening of travel distance simultaneously occur in a transfer robot, the AI recommends battery replacement or a review of a charging schedule. When an image recognition error and a camera calibration abnormality simultaneously occur in an inspection robot, the AI proposes readjustment of a camera or inspection of an illumination system. Specifically, the present trend analysis and response unit uses a deep generative model called an autoencoder as an anomaly detection engine. The present system inputs a multidimensional time-series tensor such as a motor temperature, a vibration spectrum, and a torque value collected during normal operation to an encoder network of the autoencoder. The present encoder network compresses the input tensor into a low-dimensional latent variable vector. The present system inputs this latent variable vector to a decoder network, and reconstructs the original input tensor. The present system calculates a mean square error between the input tensor and the reconstructed tensor as a reconstruction error. The present system uses this reconstruction error as an anomaly score. When new sensor data is input during operation, the present system similarly calculates a reconstruction error. The present system detects an abnormality by utilizing a property that when an unknown abnormal pattern such as grease deterioration of a reduction gear occurs, the model cannot appropriately reconstruct the pattern, and the reconstruction error rapidly increases. When the anomaly score exceeds a dynamic threshold, the present system texturizes the sensor data and the latest event log at that time, and inputs them as a prompt of a large language model. The present large language model extracts a correlation between events of “a gradual rise in motor temperature” and “an increase in vibration value” from the input text. The present large language model refers to a vector search result of a past maintenance manual or a failure case database. The present large language model outputs a specific probability distribution such as “a grease deterioration probability of a reduction gear of 75 percent, a bearing wear probability of 20 percent” as an inference result. The present large language model generates a specific response procedure for a cause with the highest probability in natural language. By this series of processes, the present system automatically derives not merely an alert of exceeding a threshold but identification of a root cause and a specific action plan. The present system formalizes advanced tacit knowledge possessed by a skilled maintenance engineer as an algorithm, and completely automates a predictive maintenance process of a factory.

The AI learns a past failure occurrence pattern and a normal operation pattern, and compares them with current log data, thereby extracting a complex abnormal pattern and a sign of failure occurrence that are difficult to detect by conventional threshold monitoring. For example, when an error code E45 occurs three times in the past week and a torque sensor value records an abnormal value immediately after that, the AI estimates an abnormality in a part supply system, deterioration of a cooling fan in a control panel, or the like. When minor errors occur simultaneously and frequently in a plurality of robots, the AI estimates an abnormality in a power supply system or an air conditioning system of an entire line, or a change in production conditions. Specifically, the present system pre-trains a neural network model using contrastive learning, which is a method of self-supervised learning. The present system randomly cuts out two partial sequences from a time-series sequence of a normal operation log. The present system performs data augmentation processing such as noise addition and time warping on these two sequences. The present system inputs the augmented sequences to an encoder network, and acquires respective feature vectors. The present system updates a weight parameter so as to maximize a cosine similarity between feature vectors generated from the same original sequence and minimize a similarity between feature vectors generated from different sequences. By this contrastive learning, the present system acquires an essential feature representation of a normal pattern with high accuracy even in an environment where labeled abnormal data is extremely small. In an operation phase, the present system inputs log data input in real time to this trained encoder, and extracts a feature vector. The present system plots the extracted feature vector on a latent space. The present system calculates a trajectory in which a current state vector starts to deviate from a boundary of a normal cluster. The present system utilizes that a combination of seemingly unrelated events, for example, frequent occurrence of a specific error code and a minute fluctuation in torque value, is expressed as a clear vector toward a specific failure mode on the latent space. By analyzing a direction and a speed of this trajectory, the present system predicts a fatal failure that will occur several days later. The present system inputs feature vectors obtained from a plurality of robots to a graph neural network, and calculates a spatial correlation. By this calculation, the present system identifies not an abnormality of an individual robot but a common factor such as a voltage drop of a power supply system that affects the entire line. By using a non-linear operation in a high-dimensional space, the present system elucidates a complex causal relationship exceeding human cognitive limits. The present system provides an extremely powerful technical improvement directly linked to an improvement in yield and maximization of overall equipment effectiveness in a manufacturing industry.

When a failure or an abnormality is detected, the AI automatically notifies a maintenance department of a detailed log, an estimated cause, and a recommended countermeasure of a corresponding device, and presents a specific countermeasure such as “recommending greasing of a reduction gear from a motor temperature rise and a vibration value increase of a welding robot A01”, “recommending nozzle replacement from frequent nozzle clogging of a painting robot B02”, and “recommending replacement of an end effector from an increase in torque variation of an assembly robot C03”, for example. As necessary, the AI simultaneously proposes a line stop and a production plan change to a production management department, and realizes automatic coordination such as “proposing a temporary stop of a corresponding line and switching to an alternative line for inspection of the assembly robot C03” and “recommending a line configuration change in a night shift for battery replacement of a transfer robot group”, for example. Specifically, the present notification processing unit receives a result output from an anomaly detection model. The present anomaly detection model has a complex architecture combining a neural network for time-series analysis and a large language model. The present anomaly detection model receives multidimensional time-series sensor data as input data. This input data includes, for example, a time-series array of motor temperatures for the past 24 hours, a three-dimensional vector of vibration acceleration, and a fluctuation history of torque values. The present anomaly detection model executes normalization processing and missing value completion processing on the input data. The present anomaly detection model converts the processed data into a tensor format. The present anomaly detection model inputs the converted tensor to an encoder having a self-attention mechanism. The present anomaly detection model calculates an anomaly probability score as output data. This anomaly probability score is expressed as a floating-point number from 0.0 to 1.0. The present anomaly detection model further outputs a cause classification label. This cause classification label is, for example, an integer value indicating grease deterioration, an integer value indicating nozzle clogging, or an integer value indicating part wear. The present anomaly detection model also outputs a recommended action ID. The present notification processing unit determines whether or not the output anomaly probability score exceeds a preset threshold. When the threshold is exceeded, the present notification processing unit extracts a natural language text corresponding to the recommended action ID from a database. The present notification processing unit transmits the extracted text to a terminal of the maintenance department via a network. The present notification processing unit simultaneously communicates with a production management system via an application programming interface. The present notification processing unit transmits parameters of a line stop request and a schedule change request to the production management system. The present system executes these processes in milliseconds without human intervention. The present system completely replaces a conventional log visual confirmation work by a human. By this automation, the present system minimizes downtime of devices. The present system dramatically improves efficiency of maintenance work. The present system functions extremely effectively in a large-scale production line such as an automobile manufacturing factory or a semiconductor manufacturing factory.

Furthermore, the AI analyzes an operation status and a failure trend of all devices, and automatically proposes, for example, “a list of robots requiring maintenance within this week”, “a process that is a production bottleneck”, “a device for which preventive maintenance should be prioritized”, and “a production efficiency maximization plan by line reconfiguration” to an administrator. For example, the AI outputs a specific operation improvement plan such as recommending maintenance within next week from a motor temperature rise trend and a vibration value increase of a welding robot B02, proposing switching to a spare machine due to an increase in error frequency of an assembly robot C03, and recommending a line configuration change in a night shift from an operation rate of a transfer robot group. Specifically, the present optimization processing unit executes an operation optimization calculation of an entire factory using a prediction model. The present prediction model has a structure integrating a graph neural network and a reinforcement learning algorithm. The present prediction model receives an operation history vector of all devices as input data. This operation history vector includes, for example, an operation time, the number of error occurrences, and an average load factor of each device for the past one month. The present prediction model further receives an adjacency matrix indicating a dependency relationship between processes as input data. The present prediction model maps these input data to a high-dimensional feature space. The present prediction model calculates a maintenance priority score of each device as output data. This priority score is expressed as a continuous value from 0 to 100. The present prediction model further outputs a production bottleneck probability distribution. This probability distribution indicates a probability that each process becomes a bottleneck in percentage. The present prediction model outputs an optimal line configuration parameter. This parameter includes, for example, the number of operating robots, a conveyance speed of a conveyor, and the number of personnel assignments per shift. The present optimization processing unit executes a simulation based on the output parameter. The present optimization processing unit selects an operation improvement plan with the highest production efficiency from a simulation result. The present optimization processing unit inputs the selected improvement plan to a natural language generation model. The present natural language generation model generates a proposal text for the administrator. The present optimization processing unit formats the generated text as drawing data for a dashboard. The present system executes these advanced operations on a parallel operation cluster using a graphics processing unit. The present system adopts an unconventional method considering a complex interaction between devices, not merely a rule-based threshold determination. By this process, the present system maximizes production efficiency of the entire factory. The present system prevents a risk of a large-scale production stop due to a sudden failure. The present system exhibits a particularly high technical effect in a high-mix low-volume production environment such as a food processing factory or an electronic component assembly factory.

The user interface unit enables an administrator and an operation manager to view a failure occurrence alert, a response status, a trend analysis report, a preventive maintenance recommendation, an estimation basis of a failure cause, a comparison with a past similar failure, a future risk prediction, and the like in real time on a dashboard screen, and also enables a field worker to proceed with work while referring to a work procedure manual and a failure response history on a tablet terminal, the administrator to immediately grasp a failure occurrence status on a smartphone, and a management layer to comprehensively confirm an overall operation status on a laptop computer. Through the instruction input unit, when a field worker discovers a new abnormality, it is also possible to immediately input the information to the system and prompt an additional analysis by the AI and a re-notification to a related department. Specifically, the present user interface unit establishes a constant connection with a server using a WebSocket communication protocol. The present display control unit receives structured data push-distributed from the server in real time. The present display control unit dynamically redraws a screen layout based on the received data. The present display control unit renders a device layout in the factory on a virtual space using a three-dimensional graphics library. The present display control unit blinks a virtual model of a device in which an abnormality is detected in red. The present display control unit visualizes a judgment basis of an artificial intelligence model. The present display control unit superimposes and displays a weight of an attention mechanism of a neural network as a heat map on a graph. The present instruction input unit receives feedback from a field worker. The present instruction input unit receives voice waveform data of a worker as input data. The present instruction input unit receives image data captured by a camera of a mobile terminal as input data. The present instruction input unit transfers these input data to a natural language processing module and an image recognition module. The present natural language processing module converts the voice waveform data into a text character string. The present natural language processing module extracts a named entity from the text character string. The present image recognition module identifies an abnormal part from the image data. The present system generates a structured incident report as output data. This incident report includes, for example, a discovery date and time, a device identifier, an abnormality classification code, and an urgency flag. The present system transfers the generated incident report to a retraining pipeline. The present system formalizes tacit knowledge in the field, and continuously improves inference accuracy of the artificial intelligence model. The present system significantly reduces a human cognitive load. The present system dramatically increases a speed of decision making. The present system brings a technical effect of eliminating a delay in information transmission in a facility having a vast site such as a chemical plant or a steelworks.

As described above, in the embodiment of the present invention, detailed operation data and failure histories of various automated devices and peripheral devices in a factory are centrally managed, and advanced trend analysis, automatic response, and optimization proposal are realized using a generative AI, thereby enabling an improvement in an operation rate of an entire factory, minimization of downtime, reduction of maintenance costs, and realization of a flexible production system. Specifically, the present integrated control unit adopts a hybrid architecture that causes an edge computing node and a cloud server to operate cooperatively. The present integrated control unit stores tens of thousands of event data generated per second from each device in the factory in a distributed database. The present integrated control unit suppresses a data write delay to a microsecond order using an in-memory data grid. The present system makes a generative artificial intelligence model resident on a memory. The present system minimizes an overhead of inference processing. The present system implements a data-driven decision-making process as a physical arithmetic processing inside a computer. The present system converts a conventional maintenance work depending on human experience and intuition into a deterministic process based on a mathematical algorithm. The present system executes a multivariate correlation analysis in a high-dimensional space. The present system captures a sign of a minute abnormality imperceptible to a human. By this technical processing, the present system embodies a cyber-physical system. The present system synchronizes a device state in a physical space and a digital twin in an information space in milliseconds. As a result, the present system optimizes energy consumption efficiency of the entire factory. The present system reduces unnecessary part replacement, and promotes effective utilization of resources. As a fundamental technology of a smart factory, the present system strongly promotes digital transformation of all manufacturing industries.

### (System Configuration)

A system according to the present embodiment comprises a factory robot information management unit, a log collection unit, a trend analysis and response unit, a notification and coordination unit, a database unit, a user interface unit, and an instruction input unit. The factory robot information management unit centrally manages identification information, an installation location, administrator information, a serial number, a firmware version, a software version, an installation date, a warranty period, maintenance contract information, a configuration change history, a failure response history, a part replacement history, maintenance department contact information, a sensor data type, operating state information, and the like of various automated devices such as a welding robot, a painting robot, an assembly robot, a transfer robot, an inspection robot, a palletizing robot, and a collaborative robot, and peripheral devices thereof, for example, a control panel, an end effector, various sensors, a transfer line, a vision system, a force sensor, a torque sensor, a temperature sensor, a vibration sensor, an image recognition camera, a barcode reader, an RFID reader, a PLC, an industrial PC, an air conditioning facility, a power supply device, a battery management device, a cooling fan, a lubrication device, a grease supply device, an air supply device, a nozzle cleaner, a filter, an illumination device, a workbench, a protective fence, an emergency stop device, an alarm lamp, a worker detection sensor, and an access control device, and records in detail, for example, an installation line number of a welding robot, a replacement history of an end effector, a battery replacement history of a transfer robot, and a camera calibration history of an inspection robot. Specifically, the present factory robot information management unit structures and stores device information using a relational database management system. The present factory robot information management unit expands a profile of each device as a multidimensional vector on a memory. The present factory robot information management unit expresses a physical and logical dependency relationship between devices using a hierarchical tree structure. The present factory robot information management unit manages, for example, a plurality of robot groups connected to a specific power supply device as one cluster. When addition or deletion of a device occurs, the present factory robot information management unit detects a new device on a network using an automatic discovery protocol. The present factory robot information management unit automatically acquires identification information and a firmware version from the detected device. The present factory robot information management unit inserts the acquired information into a corresponding table of a database. The present factory robot information management unit assigns a B-tree index to columns of identification information and an installation location in order to improve a response speed of a search query. By this centralized management method, the present system completely eliminates data inconsistency and duplication. The present system enables searching for specific device information within several milliseconds even in a huge factory having tens of thousands of devices. The present system always provides latest and accurate context data to a subsequent artificial intelligence model. By ensuring this data quality, the present system exhibits a technical effect of dramatically reducing inference errors.

The log collection unit automatically collects operation logs, failure occurrence logs, sensor data, event logs, operation histories, worker logs, alarm histories, maintenance histories, part replacement histories, software update histories, firmware update histories, line configuration change histories, control logic change histories, abnormal events, alarm events, warning events, caution events, information events, operation events, work events, maintenance events, inspection events, cleaning events, replenishment events, replacement events, repair events, recovery events, restart events, stop events, start events, switching events, disconnection events, connection events, communication events, synchronous events, asynchronous events, batch events, real-time events, periodic events, aperiodic events, sudden events, steady events, unsteady events, abnormality detection events, abnormality cancellation events, abnormality recurrence events, abnormality unresolved events, abnormality resolved events, abnormality reporting events, abnormality unreported events, abnormality recurrence prevention events, abnormality recurrence prevention unexecuted events, abnormality recurrence prevention executed events, abnormality recurrence prevention completed events, abnormality recurrence prevention uncompleted events, abnormality recurrence prevention plan events, abnormality recurrence prevention plan unexecuted events, abnormality recurrence prevention plan executed events, abnormality recurrence prevention plan completed events, abnormality recurrence prevention plan uncompleted events, abnormality recurrence prevention plan reporting events, abnormality recurrence prevention plan unreported events, abnormality recurrence prevention plan reporting completed events, abnormality recurrence prevention plan reporting uncompleted events, and the like from each device in real time or periodically using various communication means such as SNMP, OPC UA, Modbus, EtherCAT, REST API, proprietary protocols, agent software, MQTT, FTP, via USB memory, wireless communication, short-range wireless communication, infrared communication, optical communication, satellite communication, and cloud linkage, and for example, collects a motor temperature and a vibration value of a welding robot every minute, immediately collects a nozzle clogging event of a painting robot when it occurs, records a torque sensor value of an assembly robot for each work cycle, records a remaining battery level and a travel distance of a transfer robot every 10 minutes, and records an image recognition result and the number of defective product detections of an inspection robot for each inspection cycle. Furthermore, the log collection unit also performs log normalization, format conversion, noise removal, importance determination, extraction of logs before and after a failure occurrence, automatic marking of abnormal events, automatic classification of abnormal events, automatic prioritization of abnormal events, automatic association of abnormal events, automatic influence range estimation of abnormal events, automatic cause estimation of abnormal events, automatic countermeasure proposal of abnormal events, automatic notification of abnormal events, automatic reporting of abnormal events, automatic recording of abnormal events, automatic analysis of abnormal events, automatic learning of abnormal events, automatic optimization of abnormal events, and the like. Specifically, the present log collection unit adopts a publish-subscribe model imitating a distributed messaging system. The present log collection unit asynchronously receives a data stream from each device. The present preprocessing module temporarily stores received raw data in a ring buffer on a memory. The present preprocessing module receives text logs and binary data in heterogeneous formats as input data. This input data includes, for example, comma-separated sensor values, JSON-format event notifications, or proprietary binary payloads. The present preprocessing module applies a moving average filter or a Kalman filter to remove high-frequency noise of sensor data. The present preprocessing module unifies a time zone of a time stamp to Coordinated Universal Time. The present preprocessing module generates a feature vector mapped to a common schema as output data. This feature vector includes, for example, a device ID, a time stamp, a normalized temperature value, and an event type code. The present preprocessing module writes the generated feature vector into a time-series database. By this pipeline processing, the present system optimizes consumption of a network bandwidth. The present system continuously supplies a clean data set that is easy for a subsequent artificial intelligence model to process. The present system performs distributed processing of a calculation load required for data preprocessing on an edge side. The present system brings a technical effect of concentrating CPU resources of a cloud server on advanced inference processing.

The trend analysis and response unit analyzes a huge amount of collected time-series data and event logs in multiple dimensions using a generative AI, estimates a sign of grease deterioration or bearing wear of a reduction gear when, for example, a motor temperature of a welding robot rises more slowly than usual and a vibration value shows an increasing trend at the same time, automatically generates a recommendation for nozzle cleaning or replacement when a minute fluctuation in application pressure and frequent occurrence of nozzle clogging events are simultaneously observed in a painting robot, estimates wear of an end effector or an abnormality in a part supply system when an increase in variation of torque sensor values and an increase in tightening errors are detected in an assembly robot, recommends battery replacement or a review of a charging schedule when a decrease in remaining battery level and a shortening of a travel distance occur simultaneously in a transfer robot, and proposes readjustment of a camera or inspection of a lighting system when an image recognition error and a camera calibration abnormality occur simultaneously in an inspection robot. The AI learns a past failure occurrence pattern and a normal operation pattern, and compares them with current log data to extract a complex abnormal pattern and a sign of failure occurrence that are difficult to detect by conventional threshold monitoring, estimates an abnormality in the part supply system or deterioration of a cooling fan in a control panel when, for example, an error code E45 occurs three times in the past week and a torque sensor value records an abnormal value immediately thereafter, and estimates an abnormality in a power supply system or an air conditioning system of an entire line, or a change in production conditions when minor errors occur simultaneously and frequently in a plurality of robots. When a failure or an abnormality is detected, the AI automatically notifies a maintenance department of a detailed log, an estimated cause, and a recommended countermeasure of a corresponding device, presents a specific countermeasure such as, for example, “greasing of the reduction gear is recommended based on the motor temperature rise and the vibration value increase of the welding robot A01,” “nozzle replacement is recommended based on the frequent nozzle clogging of the painting robot B02,” or “end effector replacement is recommended based on the torque variation increase of the assembly robot C03,” simultaneously proposes a line stop and a production plan change to a production management department as necessary, and realizes automatic coordination such as, for example, “proposing a temporary stop of a corresponding line and switching to an alternative line for inspection of the assembly robot C03” or “recommending a line configuration change in a night shift for battery replacement of a transfer robot group.” Furthermore, the AI analyzes an operation status and a failure trend of all devices, and automatically proposes to an administrator, for example, “a list of robots requiring maintenance within this week,” “a process that is a production bottleneck,” “a device for which preventive maintenance should be prioritized,” and “a production efficiency maximization plan by line reconfiguration.” Specifically, the trend analysis and response unit executes a deep learning model combining a long short-term memory network and a self-attention mechanism. The deep learning model receives a multivariate time-series tensor as input data. This tensor has a three-dimensional structure of a batch size, a sequence length, and a feature dimension. For example, the sequence length indicates data points every minute for the past 60 minutes, and the feature dimension indicates 50 types of sensor values such as temperature, vibration, and current value. The deep learning model is pre-trained as an autoencoder using only normal data. The deep learning model compresses the input tensor into a latent space and reconstructs it back to the original dimension. The deep learning model calculates a mean squared error between the input data and the reconstructed data. The deep learning model calculates an anomaly probability score based on this reconstruction error as output data. This score is a floating-point number in a range of 0.0 to 1.0. The deep learning model activates a classification layer when the anomaly probability score exceeds a threshold. The classification layer generates a probability distribution vector of a cause class as output data. This vector includes values such as, for example, a grease deterioration probability of 85 percent, a bearing wear probability of 10 percent, and a sensor failure probability of 5 percent. The trend analysis and response unit identifies a cause class with the highest probability. The trend analysis and response unit acquires a text template of a recommended countermeasure from a rule engine based on the identified cause. The trend analysis and response unit embeds a device ID and a current value into the template to generate a final notification message. The present system captures a minute correlation breakdown among a plurality of parameters that cannot be detected by a single sensor value, by this non-conventional processing method. The present system exhibits a technical effect of detecting a sign several days before a fatal failure occurs while reducing a false alarm rate to the utmost limit.

A notification and coordination unit centrally manages notification and coordination to various stakeholders such as the maintenance department, the production management department, a field worker, the administrator, and a management layer based on an analysis result and an anomaly detection result of the trend analysis and response unit, executes, for example, automatic contact to the maintenance department, a work request to a replacement department, an alert notification to the administrator, a work instruction to the field worker, and an escalation notification to the management layer concurrently when a failure occurs, and notification details and coordination details are automatically optimized according to the analysis result by the AI and a field situation. For example, flexible operation according to an operation policy is possible, such as immediately notifying only a highly urgent failure at night or on a holiday, and notifying all failures in detail during normal times. Furthermore, it is possible to automatically generate an optimal replacement work schedule by referring to an inventory status of replacement parts, a schedule of a person in charge of work, an access authority to a site, presence or absence of a work procedure manual, and a preparation status of necessary tools and members, and simultaneously notify related departments. Specifically, the notification and coordination unit executes a scheduling algorithm using a constraint satisfaction problem solver. The scheduling algorithm receives structured data of the anomaly detection result as input data. The scheduling algorithm further receives a person-in-charge schedule matrix and a record of an inventory database as input data. This person-in-charge schedule matrix is a two-dimensional array in which a shift time, a possessed skill level, and a current task status of each worker are digitized. The record of the inventory database includes a part number, a current inventory quantity, and a scheduled delivery date and time of a necessary replacement part. The scheduling algorithm substitutes these input data into an objective function. The scheduling algorithm performs an optimization calculation for the purpose of minimizing downtime and leveling a work load. The scheduling algorithm generates an optimized work schedule matrix as output data. This matrix includes a combination of a work start time, a person-in-charge ID, a target device ID, and a used part ID. The notification and coordination unit generates a personalized notification text for each person in charge based on the generated matrix. The notification and coordination unit transmits the generated text to an interface of an e-mail server or a chat application. The present system completely eliminates complicated contact work performed by humans via telephone or e-mail by this automatic coordination function. The present system prevents information transmission omission and arrangement mistakes. The present system brings about a technical effect of dramatically shortening a lead time from a failure occurrence to a start of recovery work.

A database unit centrally manages all data from the factory robot information management unit, the log collection unit, the trend analysis and response unit, and the notification and coordination unit, records, for example, all details from a failure occurrence to recovery in chronological order, and can utilize them for later analysis, auditing, and operation improvement. Furthermore, the database unit is also utilized as learning data for the generative AI, and contributes to continuous accuracy improvement and discovery of a new abnormal pattern. For example, based on a past failure response history, a countermeasure when a similar failure occurs is automatically proposed, a device with a high failure occurrence frequency is extracted and utilized for drafting a preventive maintenance plan, and feedback details are optimized according to a situation of an operation site and a skill of a person in charge. Specifically, the database unit functions as a data lake constructed on a distributed file system. The database unit integrally accumulates structured data and unstructured data. A learning pipeline periodically batch-processes the accumulated data. The learning pipeline receives a past failure response text as input data. The learning pipeline converts the text into a multidimensional embedding vector using a natural language processing model. This embedding vector is, for example, an array of 768-dimensional floating-point numbers. The database unit indexes and stores the generated embedding vector in a vector database. When a new failure occurs, an inference engine similarly vectorizes a text indicating the failure situation. The inference engine executes a cosine similarity calculation on the vector database. The inference engine extracts a list of past failure records with the highest similarity score as output data. This list includes a past response procedure, a used part, and a required time until resolution. The learning pipeline sequentially updates weights of the model using an online learning method. The learning pipeline calculates an error between an actual response result and a prediction result of the model. The learning pipeline optimizes parameters of a neural network using a gradient descent method. The present system autonomously adapts to an environmental change of a factory and aging deterioration of a device by this self-learning mechanism. The present system provides a scalable technical effect in which inference accuracy improves as an operation period becomes longer.

A user interface unit enables the administrator and the operation manager to view a failure occurrence alert, a response status, a trend analysis report, a preventive maintenance recommendation, an estimation basis of a failure cause, a comparison with a past similar failure, a future risk prediction, and the like in real time on a dashboard screen, and also enables the field worker to proceed with work while referring to a work procedure manual and a failure response history on a tablet terminal, the administrator to immediately grasp a failure occurrence situation on a smartphone, and the management layer to comprehensively confirm an overall operation situation on a laptop computer. Specifically, the user interface unit generates a layout that dynamically adapts to various screen sizes using a responsive web design technology. A drawing engine executes a client-side script operating on a web browser. The drawing engine parses a JSON format dataset asynchronously acquired from a server. The drawing engine draws a line graph, a pie chart, and a gauge chart in an SVG format based on the parsed data. The drawing engine visualizes an output result of an artificial intelligence model. The drawing engine receives a weight matrix of an attention mechanism of an anomaly detection model as input data. The drawing engine generates a heatmap image in which this weight matrix is converted into a color map as output data. The drawing engine superimposes and displays the generated heatmap on a background of a time-series graph. Thereby, a user can intuitively understand which sensor value in which time zone contributed most to an abnormality determination. The user interface unit provides work support information using an augmented reality technology to the tablet terminal of the field worker. The user interface unit overlay-draws a highlight display of a replacement target part and an arrow indicating a removal direction on a camera image. The present system converts an internal state of a complex machine learning model into a human-interpretable format by these advanced visualization processes. The present system prevents black-boxing and improves user reliability on the system. The present system brings about a technical effect of realizing uniform and high-quality maintenance work without depending on a skill level of the field worker.

An instruction input unit provides a function for the administrator, the operation manager, and the field worker to transmit an additional instruction, a comment, a report of a field situation, a work completion report, approval/rejection of a failure response, and the like to the system, and can prompt additional analysis by the AI and re-notification to a related department by immediately inputting information to the system when, for example, the field worker discovers a new abnormality during work. Specifically, the instruction input unit provides a hands-free input interface integrating a voice recognition application programming interface. The instruction input unit receives PCM format voice waveform data acquired from a microphone of a worker as input data. A natural language processing module decodes the voice waveform data into a text character string using an acoustic model and a language model. The natural language processing module executes morphological analysis and syntactic analysis on the decoded text. The natural language processing module extracts a named entity from the text. The natural language processing module generates a structured JSON object as output data. This JSON object includes, for example, a tag name of a target device, a keyword of an observed symptom, and a finding text of the worker. The instruction input unit transmits the generated JSON object to a REST endpoint of the server as an HTTP POST request. A processing unit on the server side updates a status flag of the database based on the received data. The processing unit on the server side immediately triggers a re-analysis pipeline when new abnormality information is included. The present system enables reliable data input even in a field environment where touch panel operation is difficult due to oil stains, wearing of gloves, or the like, by this input mechanism. The present system reflects a real-time situation change in the field in a digital space without delay. The present system exhibits a technical effect of speeding up a human-in-the-loop feedback cycle and improving an adaptive capability of the entire system.

Specific examples of a prompt sentence to be read into the generative AI necessary for carrying out the present invention include “Analyze the following time-series log data and error histories of a welding robot, a painting robot, an assembly robot, and a transfer robot, extract an abnormality sign and a sign of failure occurrence, and output an estimated failure cause and a recommended countermeasure in detail in Japanese.”, “List devices requiring maintenance within the next one week from sensor data and operation logs of the following robot group, and explain a priority and a reason.”, and “Analyze a robot operation status and a failure trend of an entire production line, and propose an optimal line reconfiguration plan and production schedule.” Specifically, a prompt generation unit constructs a context-aware input text using a dynamic prompt engineering technology. The prompt generation unit receives a system prompt, a user prompt, and context data as input data. This context data is a JSON format character string including a log excerpt of the latest 24 hours extracted from the database and a statistic of a sensor value. The prompt generation unit combines these data and adjusts the number of tokens so as to fit within a context window size of a large language model. The prompt generation unit inputs the adjusted text to an encoder of the large language model. The large language model is based on a transformer architecture having billions of parameters. The large language model autoregressively predicts a next token. The large language model generates a markdown format report text as output data. This report text includes, for example, a heading, a bulleted list, and a bold decoration emphasizing an important part. The prompt generation unit applies a post-processing filter to the output text. The prompt generation unit detects and corrects an inappropriate expression and a format collapse. The present system strongly suppresses a hallucination phenomenon peculiar to the large language model by this strict prompt management. The present system always outputs an accurate and consistent analysis result based on facts. The present system realizes a technical effect of safely incorporating an advanced inference capability by natural language into a control logic of an industrial system.

As described above, the system according to the present embodiment centrally manages detailed operation data and failure histories of various automated devices and peripheral devices in a factory, and realizes advanced trend analysis, automatic response, and optimization proposal using the generative AI, thereby enabling an improvement in an operation rate of the entire factory, minimization of downtime, reduction of maintenance costs, and realization of a flexible production system. Specifically, this integrated architecture seamlessly links real-time processing in an edge device and large-scale batch processing in a cloud environment. The present system aggregates petabyte-class big data collected from each device into the data lake. The present system executes parallel computing using a distributed processing framework. The present system constructs a closed-loop control system that feeds back an inference result of a machine learning model to a physical device as a control signal. The present system has a mechanism in which a calculation result inside a computer directly changes an operation in a physical world, not limited to mere display and notification of information. The present system realizes an autonomous self-healing function of a manufacturing line by complete implementation of this cyber-physical system. The present system instantaneously executes optimal parameter adjustment and securing of an alternative route without waiting for human intervention. As a result, the present system brings overall equipment effectiveness of the factory close to a theoretical limit value. The present system brings about a technical effect of minimizing a setup change time in high-mix variable-volume production and acquiring extremely high responsiveness to market demand fluctuation.

### (Implementation Steps)

### Step 1: Centralized Registration and Management of Factory Robot and Peripheral Device Information

The factory robot information management unit centrally registers and manages identification information, an installation location, administrator information, a serial number, a firmware version, a software version, an installation date, a warranty period, maintenance contract information, a configuration change history, a failure response history, a part replacement history, maintenance department contact information, a sensor data type, operating state information, and the like of automated devices such as a welding robot, a painting robot, an assembly robot, a transfer robot, an inspection robot, a palletizing robot, and a collaborative robot, and a control panel, an end effector, various sensors, a transfer line, a vision system, a force sensor, a torque sensor, a temperature sensor, a vibration sensor, an image recognition camera, a barcode reader, an RFID reader, a PLC, an industrial PC, an air conditioning facility, a power supply device, a battery management device, a cooling fan, a lubrication device, an air supply device, a nozzle cleaner, a filter, a lighting device, a workbench, a protective fence, an emergency stop device, an alarm lamp, a worker detection sensor, an access control device, and the like, and records in detail, for example, an installation line number of the welding robot, a replacement history of the end effector, a battery replacement history of the transfer robot, and a camera calibration history of the inspection robot. Specifically, a registration processing unit monitors a broadcast packet on a network. The registration processing unit automatically acquires a MAC address and an IP address of a newly connected device. The registration processing unit accesses a management port of a target device using the acquired address. The registration processing unit reads a hardware specification and a setting parameter from a register inside the device. A database management system registers the read data as a node of a graph database. The database management system defines a physical connection relationship and a communication path between devices as an edge. The database management system receives profile information of the device as input data. The database management system generates a unique global identifier as output data and assigns it to each node. The present system completely automates initial setting work at the time of large-scale factory start-up or line change by this automatic registration mechanism. The present system eliminates a setting mistake and a registration omission due to manual input. The present system exhibits a technical effect of always maintaining the latest network topology and speeding up a process of identifying a failure influence range in a subsequent stage.

### Step 2: Automatic Collection and Normalization of Various Logs and Sensor Data

The log collection unit automatically collects an operation log, a failure occurrence log, sensor data, an event log, an operation history, a worker log, an alarm history, a maintenance history, a part replacement history, a software update history, a firmware update history, a line configuration change history, a control logic change history, an abnormal event, an alarm event, a warning event, a caution event, an information event, an operation event, a work event, a maintenance event, an inspection event, a cleaning event, a replenishment event, a replacement event, a repair event, a recovery event, a restart event, a stop event, a start event, a switching event, a disconnection event, a connection event, a communication event, a synchronous event, an asynchronous event, a batch event, a real-time event, a periodic event, an aperiodic event, a sudden event, a steady event, an unsteady event, and the like from each device in real time or periodically using various communication means such as SNMP, OPC UA, Modbus, EtherCAT, a REST API, a proprietary protocol, agent software, MQTT, FTP, via a USB memory, wireless communication, and cloud linkage, and also performs log normalization, format conversion, noise removal, importance determination, extraction of logs before and after a failure occurrence, automatic marking of an abnormal event, automatic classification of an abnormal event, automatic prioritization of an abnormal event, automatic association of an abnormal event, automatic influence range estimation of an abnormal event, automatic cause estimation of an abnormal event, automatic countermeasure proposal of an abnormal event, automatic notification of an abnormal event, automatic reporting of an abnormal event, automatic recording of an abnormal event, automatic analysis of an abnormal event, automatic learning of an abnormal event, automatic optimization of an abnormal event, and the like. Specifically, a data collection pipeline ingests millions of data points per second using a stream processing engine. A normalization engine receives a raw data stream having a different encoding or unit system as input data. This raw data stream includes, for example, temperature data in which Celsius and Fahrenheit are mixed, and a timestamp of a different time zone. The normalization engine unifies a unit into an international system of units by referring to a lookup table. The normalization engine applies a linear interpolation algorithm to a missing value to make data continuous. The normalization engine generates a fixed-length floating-point array as output data. An event processing engine calculates a statistic for the normalized array by a sliding window method. The event processing engine marks a section in which a variance or a standard deviation exceeds a predetermined threshold as an abnormal event. The present system eliminates data siloing in a heterogeneous environment by this advanced preprocessing. The present system provides high-quality learning data without noise to a machine learning model in a subsequent stage. The present system brings about a technical effect of improving a convergence speed of a model and suppressing variation in inference.

### Step 3: Trend Analysis, Anomaly Detection, and Sign Extraction by Generative AI

The trend analysis and response unit analyzes a huge amount of collected time-series data and event logs in multiple dimensions using the generative AI, estimates a sign of grease deterioration or bearing wear of a reduction gear when, for example, a motor temperature of a welding robot rises more gradually than usual and a vibration value shows an increasing trend at the same time, automatically generates a recommendation for nozzle cleaning or replacement when minute fluctuations in application pressure and frequent occurrences of nozzle clogging events are simultaneously observed in a painting robot, estimates wear of an end effector or an abnormality in a part supply system when an increase in variation of torque sensor values and an increase in tightening errors are detected in an assembly robot, recommends battery replacement or a review of a charging schedule when a decrease in remaining battery level and a shortening of travel distance occur simultaneously in a transfer robot, and proposes readjustment of a camera or inspection of an illumination system when an image recognition error and a camera calibration abnormality occur simultaneously in an inspection robot. Specific examples of prompt sentences to be read into the generative AI include “Analyze the following time-series log data and error histories of the welding robot, the painting robot, the assembly robot, and the transfer robot, extract an abnormality sign and a sign of failure occurrence, and output an estimated failure cause and a recommended countermeasure in detail in Japanese.”, “List devices requiring maintenance within the next one week from sensor data and operation logs of the following device group, and explain a priority and a reason.”, and “Analyze a robot operation status and a failure occurrence trend of an entire production line, and propose an optimal line reconfiguration plan and production schedule.” Specifically, the present inference engine executes a tokenization process of time-series data. The present inference engine divides continuous sensor values into discrete patches. The present inference engine linearly projects each patch to generate an embedding vector. The present inference engine supplies a sequence of this embedding vector as input data to a transformer encoder. This input data is, for example, a tensor in which feature vectors having 512 dimensions are continuous for 1024 steps. The present transformer encoder simultaneously learns dependencies of different time scales using a multi-head attention mechanism. The present inference engine calculates an abnormality occurrence probability at each time step as output data. This probability is output as a floating-point number from 0.0 to 1.0. When the abnormality probability exceeds a threshold, the present inference engine passes the context vector to a decoder of a large language model. The present large language model generates an explanatory text in natural language as output data. This explanatory text includes a specific basis, for example, “The motor temperature has risen by 2 degrees in the past 4 hours, and at the same time, a high-frequency vibration component has increased by 30 percent. This suggests initial wear of the bearing.” The present system seamlessly integrates statistical anomaly detection of numerical data and semantic interpretation by natural language by this complex artificial intelligence architecture. The present system exhibits a technical effect of providing a highly advanced analysis result in a form that a field worker can intuitively understand even without a specialized data scientist.

### Step 4: Automatic Response and Related Department Coordination When Failure Occurs

The trend analysis and response unit and a notification and coordination unit automatically notify a maintenance department of a detailed log, an estimated cause, and a recommended countermeasure of a corresponding device when a failure or an abnormality is detected based on an analysis result or an anomaly detection result by the generative AI, present a specific countermeasure such as “Recommend greasing of the reduction gear from the motor temperature rise and the vibration value increase of the welding robot A01”, “Recommend nozzle replacement from the frequent nozzle clogging of the painting robot B02”, and “Recommend replacement of the end effector from the torque variation increase of the assembly robot C03”, simultaneously propose a line stop and a production plan change to a production management department as necessary, and realize automatic coordination such as “Propose a temporary stop of the corresponding line and switching to an alternative line for inspection of the assembly robot C03” and “Recommend a line configuration change in a night shift for battery replacement of the transfer robot group”. A specific example of a prompt sentence to be read into the generative AI includes “Automatically generate a notification text to the maintenance department and a coordination proposal text to the production management department based on a log at the time of failure occurrence and a past failure response history.” Specifically, the present automatic response module drives a workflow engine to automatically generate a series of tasks. The present automatic response module receives a JSON object of an anomaly detection event as input data. The present automatic response module further receives current production schedule data and a contact master of each department as input data. The present automatic response module specifies an influence range of the failure using a rule-based inference engine. The present automatic response module extracts a list of affected subsequent processes. The present coordination algorithm generates an updated production schedule matrix as output data. This matrix includes a change in allocation of a production lot to an alternative line and an instruction to extend an operating time. The present automatic response module generates an action item list for each department as output data. This list includes specific tasks such as “picking of part number XX and moving to the site” for the maintenance department and “change of transfer destination of lot number YY” for the production management department, for example. The present automatic response module registers these tasks in a task management system of each department via an application programming interface. The present system shortens an initial response time at the time of incident occurrence to a level of several seconds by this automated orchestration. The present system brings about a technical effect of reducing a communication cost between departments and completely preventing a secondary production delay due to a communication error.

### Step 5: Feedback of Response Result and Trend Analysis Result and Operation Optimization Proposal

The trend analysis and response unit and the notification and coordination unit automatically feed back a response result and a trend analysis result to an administrator and an operation manager, and display a failure occurrence status, a response progress status, a trend analysis report, a preventive maintenance recommendation, an estimated basis of a failure cause, a comparison with a past similar failure, a future risk prediction, a process that is a production bottleneck, a device for which preventive maintenance should be prioritized, a production efficiency maximization plan by line reconfiguration, and the like on a dashboard in real time through a user interface unit, and a field worker can proceed with work while referring to a work procedure manual and a failure response history on a tablet terminal, the administrator can immediately grasp the failure occurrence status on a smartphone, and a management layer can also comprehensively confirm an overall operation status on a notebook computer. Specific examples of prompt sentences to be read into the generative AI include “Analyze operation logs and failure trends of all robots, and output a list of robots requiring maintenance within this week and reasons thereof.” and “Propose an optimal line reconfiguration plan and production schedule from data of the entire production line.” Specifically, the present feedback processing unit executes continuous optimization of operation parameters using a reinforcement learning agent. The present optimization engine receives a log of a past response history as input data. The present optimization engine further receives a downtime reduced or a yield rate improved by the response as a reward signal as input data. The present optimization engine searches for an optimal policy in a Markov decision process using a policy gradient method. The present optimization engine calculates an update parameter of a next anomaly detection threshold as output data. This update parameter includes a specific numerical change such as lowering a determination threshold for a temperature abnormality by 0.5 degrees or extending a monitoring window for vibration by 10 seconds, for example. The present optimization engine generates a JSON file of an optimized operation policy as output data. The present feedback processing unit distributes this JSON file to each edge device to dynamically update a control logic. In the present system, the system itself autonomously evolves through experience by this closed-loop feedback mechanism. The present system maintains and improves the accuracy of the model without human intervention against long-term environmental changes such as seasonal variations and aging deterioration of devices. The present system exhibits a technical effect of continuously reducing an operation cost and maximizing a return on investment over the entire life cycle of a factory.

### (Specific Use Case)

For example, when the system of the present invention is applied to a production line of an automobile parts factory, various automated devices such as a welding robot, an assembly robot, a transfer robot, an inspection robot, a painting robot, a palletizing robot, and a collaborative robot, and peripheral devices thereof are targeted. A factory robot information management unit centrally manages identification information, an installation line number, an installation area, installation coordinates, an installation date, administrator information, a serial number, a firmware version, a software version, a warranty period, maintenance contract information, a configuration change history, a failure response history, a part replacement history, maintenance department contact information, a sensor data type, and operating state information of each robot and peripheral device. For example, various data such as a torch temperature transition, an electrode wear degree, a welding quality determination result, and the number of abnormal arc occurrences of the welding robot, a torque sensor value, a tightening torque history, a part supply error, and an assembly quality determination of the assembly robot, a travel distance, a remaining battery level, and an obstacle detection history of the transfer robot, an image recognition result, the number of defective product detections, and a camera calibration history of the inspection robot, an application pressure, a nozzle clogging detection, and an application unevenness determination of the painting robot, a load sensor value of the palletizing robot, and a force sensor value and a worker detection sensor value of the collaborative robot are recorded in detail. Specifically, the system in the present application example realizes stable data collection under a severe electromagnetic noise environment in which devices on a scale of several thousands operate. The present data collection node functions as an edge computer arranged in the vicinity of each device. The present data collection node dynamically changes a sampling rate of a sensor according to an operating state of the device. The present data collection node raises the sampling rate to 1 kilohertz during arc generation of the welding robot and lowers it to 1 hertz during standby, for example. The present data collection node encodes acquired data on a memory using a compression algorithm. The present data collection node asynchronously writes the compressed binary data to a key-value store type time-series database. The present system receives high-frequency sensor waveform data as input data. The present system transmits a summary vector subjected to downsampling and feature extraction to a cloud side as output data. The present system prevents depletion of a network bandwidth by this hierarchical data processing architecture. The present system ensures scalability in a large-scale factory. The present system brings about a technical effect of buffering data on an edge side even during a communication failure and completely preventing data loss.

The log collection unit automatically collects operation logs, failure occurrence logs, sensor data, event logs, operation histories, worker logs, alarm histories, maintenance histories, part replacement histories, software update histories, firmware update histories, line configuration change histories, control logic change histories, abnormal events, alarm events, warning events, caution events, information events, operation events, work events, maintenance events, inspection events, cleaning events, replenishment events, replacement events, repair events, recovery events, restart events, stop events, start events, switching events, communication events, synchronous events, asynchronous events, batch events, real-time events, periodic events, aperiodic events, sudden events, steady events, unsteady events, and the like from each device in real time or periodically using various communication means such as SNMP, OPC UA, Modbus, EtherCAT, a REST API, agent software, MQTT, FTP, wireless communication, and cloud linkage, and also performs log normalization, format conversion, noise removal, importance determination, extraction of logs before and after a failure occurrence, automatic marking of abnormal events, automatic classification of abnormal events, automatic prioritization of abnormal events, automatic association of abnormal events, automatic influence range estimation of abnormal events, automatic cause estimation of abnormal events, automatic countermeasure proposal of abnormal events, automatic notification of abnormal events, automatic reporting of abnormal events, automatic recording of abnormal events, automatic analysis of abnormal events, automatic learning of abnormal events, automatic optimization of abnormal events, and the like. Specifically, the present log collection module publishes and subscribes to data via a distributed messaging broker. The present event processing engine receives batch data of unstructured text logs as input data. This batch data includes, for example, tens of thousands of lines of system log character strings transmitted from each device per minute. The present event processing engine analyzes the logs using a regular expression-based parser and a natural language processing model in combination. The present event processing engine executes named entity recognition from text. The present event processing engine generates a structured event record as output data. This event record includes tagged key-value pairs such as a device ID, an error status, and an importance level. The present event processing engine caches the generated record in an in-memory database. The present event processing engine immediately routes a record whose importance level is classified as critical to a subsequent anomaly detection module. The present system prevents a load from concentrating on a specific node by this asynchronous and distributed processing pipeline. The present system eliminates a single point of failure and dramatically improves fault tolerance of the entire system. The present system exhibits a technical effect of extracting a truly important incident from a huge amount of log data with a delay in milliseconds.

The trend analysis and response unit uses the generative AI to estimate a sign of grease deterioration or bearing wear of a reduction gear when, for example, a motor temperature of a welding robot rises more gradually than usual and a vibration value shows an increasing trend at the same time, estimates wear of an end effector or an abnormality in a part supply system when an increase in variation of torque sensor values and an increase in tightening errors are detected in an assembly robot, recommends battery replacement or a review of a charging schedule when a decrease in remaining battery level and a shortening of travel distance occur simultaneously in a transfer robot, proposes readjustment of a camera or inspection of an illumination system when an image recognition error and a camera calibration abnormality occur simultaneously in an inspection robot, and automatically generates a recommendation for nozzle cleaning or replacement when minute fluctuations in application pressure and frequent occurrences of nozzle clogging events are simultaneously observed in a painting robot. The AI learns a past failure occurrence pattern and a normal operation pattern and compares them with current log data to extract a complex abnormal pattern and a sign of failure occurrence that are difficult to detect by conventional threshold monitoring, estimates an abnormality in a part supply system or deterioration of a cooling fan in a control panel when, for example, an error code E45 occurs three times in the past one week and a torque sensor value records an abnormal value immediately thereafter, and estimates an abnormality in a power supply system or an air conditioning system of an entire line or a change in production conditions when minor errors occur simultaneously and frequently in a plurality of robots. Specifically, the present trend analysis and response unit deploys a complex artificial intelligence architecture combining a neural network for time-series data analysis and a large language model on a memory. The present trend analysis and response unit converts time-series sensor data collected from each robot into a multidimensional numerical vector. The present trend analysis and response unit configures the converted numerical vector as a time-series array. The present trend analysis and response unit inputs this time-series array to a long short-term memory network or a transformer-based encoder. The present encoder extracts a high-dimensional feature tensor from the input time-series array. For example, input data to the present encoder is a 128-dimensional time-series array including a motor temperature for the past 24 hours, a vibration value by a three-axis acceleration sensor, and a current consumption value. As another example, input data to the present encoder is a 64-dimensional time-series array including an output voltage value of a torque sensor and a pulse signal interval of an encoder. The present encoder outputs a 256-dimensional feature tensor capturing a temporal dependency and a minute fluctuation pattern from these input data. The present trend analysis and response unit inputs the extracted feature tensor to a multilayer perceptron for anomaly detection. The present multilayer perceptron calculates an anomaly score indicating a degree of deviation from a normal operation pattern. The present multilayer perceptron outputs a probability distribution indicating a type of anomaly when the anomaly score exceeds a predetermined threshold. For example, an output of the present multilayer perceptron is probability distribution data indicating that a probability of grease deterioration is 85 percent, a probability of bearing wear is 12 percent, and normal is 3 percent. As another example, an output of the present multilayer perceptron is numerical data indicating that a probability of end effector wear is 90 percent. The present trend analysis and response unit integrates this probability distribution data and an operation log text of the device. The present trend analysis and response unit maps the integrated data to a prompt input space of the large language model. The present large language model calculates a hidden correlation between numerical data and text data using a self-attention mechanism. The present large language model outputs structured text data including an estimated reason for a specific failure cause and a recommended countermeasure based on a calculation result. The present system transfers this structured text data to a subsequent notification module. The present system specifies a non-linear relationship among multiple variables that cannot be discovered by human intuition or a simple rule base by matrix calculation in a high-dimensional space. The present system dramatically reduces false detections by this unconventional processing method. The present system exhibits a remarkable technical effect of preventing downtime of the entire factory by this processing. The present system dramatically improves preventive maintenance accuracy of devices in highly automated application fields such as an automobile manufacturing line and a semiconductor manufacturing factory. The present system optimizes a weight parameter using a cross-entropy error function during learning of a model. The present system minimizes an error using a gradient descent method. The present system executes a process of adding minute Gaussian noise to normal data as a data augmentation method. The present system thereby improves generalization performance of the model.

When a failure or an abnormality is detected, the AI automatically notifies the maintenance department of a detailed log, an estimated cause, and a recommended countermeasure of a corresponding device, presents a specific countermeasure such as “Recommend greasing of the reduction gear from the motor temperature rise and the vibration value increase of the welding robot A01”, “Recommend nozzle replacement from the frequent nozzle clogging of the painting robot B02”, and “Recommend replacement of the end effector from the torque variation increase of the assembly robot C03”, simultaneously proposes a line stop and a production plan change to the production management department as necessary, and realizes automatic coordination such as “Propose a temporary stop of the corresponding line and switching to an alternative line for inspection of the assembly robot C03” and “Recommend a line configuration change in a night shift for battery replacement of the transfer robot group”. Furthermore, the AI analyzes an operation status and a failure occurrence trend of all devices, and automatically proposes, for example, “a list of robots requiring maintenance within this week”, “a process that is a production bottleneck”, “a device for which preventive maintenance should be prioritized”, and “a production efficiency maximization plan by line reconfiguration” to the administrator. Specifically, the present notification and coordination unit receives the structured text data and the anomaly score output from the trend analysis and response unit. The present notification and coordination unit executes a dynamic routing algorithm based on the received data. The present notification and coordination unit calculates an evaluation function that quantifies an urgency and an influence range of the anomaly. The present evaluation function inputs the anomaly score, an importance coefficient of a target device in a production line, and presence or absence of an alternative device as variables. The present evaluation function outputs an urgency score from 0 to 100. When the urgency score exceeds a first threshold, the present notification and coordination unit transmits an alert packet to a terminal of the maintenance department using an immediate interrupt communication protocol. When the urgency score exceeds a second threshold, the present notification and coordination unit calls an application programming interface of a production management server. The present notification and coordination unit transmits a control payload including a line stop command and an alternative routing parameter to the production management server. The present system integrally analyzes log data collected from a plurality of devices using a large language model. An input to the present large language model is text data including a status code indicating an operating state of each device, a numerical array indicating an error occurrence frequency, and a past maintenance history. For example, input data to the present large language model is multimodal data combining a time-series tensor indicating an operation rate transition of all robots for the past 30 days and a natural language text of a part replacement history. As another example, input data to the present large language model is graph structure data indicating topology information of a production line. The present large language model outputs a proposal regarding optimization of the entire factory from these input data. An output of the present large language model is structured data in a JSON format including a list of maintenance recommended devices. For example, an output of the present large language model includes numerical data indicating a device identifier, a recommended maintenance date and time, and an expected downtime reduction effect. As another example, an output of the present large language model is step-by-step text data indicating a line reconfiguration procedure for maximizing production efficiency. The present system stores the output structured data in a database unit. The present system supplies the stored data to a rendering engine of a user interface unit. The present system automates a complex production plan coordination work manually performed by a human administrator by an optimization algorithm using graph theory and deep learning. The present system thereby realizes real-time reconfiguration of a production line while suppressing consumption of computer resources. The present system brings about a technical effect of maximizing throughput of a factory and reducing useless traffic of a communication network by this technical improvement. The present system is extremely effective in an application field performing high-mix low-volume production such as a food processing factory and an electronic component assembly factory.

The user interface unit enables the administrator and the operation manager to view a failure occurrence alert, a response status, a trend analysis report, a preventive maintenance recommendation, an estimated basis of a failure cause, a comparison with a past similar failure, a future risk prediction, and the like on a dashboard screen in real time, and a field worker can proceed with work while referring to a work procedure manual and a failure response history on a tablet terminal, the administrator can immediately grasp the failure occurrence status on a smartphone, and a management layer can also comprehensively confirm an overall operation status on a notebook computer. Through an instruction input unit, when a field worker discovers a new abnormality, it is also possible to immediately input the information to the system and prompt additional analysis by the AI and re-notification to related departments. Specifically, the present user interface unit establishes a persistent connection with a server using a WebSocket communication protocol. The present user interface unit asynchronously receives a binary data stream push-distributed from the server. The present user interface unit decodes the received binary data on a memory on a client side. The present user interface unit dynamically updates a virtual document object model using the decoded data. The present user interface unit executes a visualization process of multidimensional data using hardware acceleration of a graphics processing unit. The present user interface unit superimposes and displays an operating state of each device as a heat map on a floor map of a factory, for example. The present user interface unit receives feedback data from a field worker via the instruction input unit. The present instruction input unit preprocesses input text data and image data. The present instruction input unit formats the preprocessed data as an input tensor to a natural language processing model or an image recognition model. For example, input data to the present instruction input unit is a high-resolution image tensor of a damaged part photographed by a worker. As another example, input data to the present instruction input unit is a free-description text vector regarding an abnormal noise input by a worker. The present system transmits these input data to a re-learning module on a server side. The present re-learning module fine-tunes a weight parameter of an anomaly detection model using the received data as training data. The present re-learning module applies an online learning algorithm to continuously update the model. The present system improves inference accuracy of the model over time by this feedback loop. The present system is not limited to mere display of information, but optimizes a distributed processing architecture between an edge device and a cloud server. The present system minimizes consumption of a network bandwidth by performing filtering and compression of data on an edge side. The present system exhibits a technical effect of improving a response speed of the entire system by this improvement in data management. The present system reduces a travel time of a worker and supports quick decision-making in an application field such as a chemical plant having a vast site and a large-scale logistics center. The present system implements an access control logic that dynamically changes a granularity of data to be displayed according to an authority level of a user. The present system thereby provides necessary information without delay while ensuring information security.

Specific examples of prompt sentences to be read into the generative AI include “Analyze the following time-series log data and error histories of the welding robot, the painting robot, the assembly robot, and the transfer robot, extract an abnormality sign and a sign of failure occurrence, and output an estimated failure cause and a recommended countermeasure in detail in Japanese.”, “List devices requiring maintenance within the next one week from sensor data and operation logs of the following device group, and explain a priority and a reason.”, and “Analyze a robot operation status and a failure occurrence trend of an entire production line, and propose an optimal line reconfiguration plan and production schedule.” Specifically, the present system deploys a prompt generation module on a memory. The present prompt generation module automatically converts raw log data extracted from a database unit into a structured prompt interpretable by a large language model. The present prompt generation module embeds a dynamic variable in a prompt using a template engine. The present prompt generation module optimizes the number of tokens of a prompt according to the number of dimensions and a data size of input data. The present system generates a complex text vector including a system prompt, context data, and a task instruction as an input to the large language model. For example, input data to the present large language model is context data including an identifier of each robot, a numerical array indicating a frequency distribution of error codes for the past seven days, and a moving average of latest sensor values. As another example, input data to the present large language model is metadata in a JSON format defining an operation constraint condition of a production line and a takt time of each process. The present large language model calculates a dependency between input tokens in a self-attention layer of a transformer architecture. The present large language model sequentially generates a probabilistically most likely next token based on a calculation result. An output of the present large language model is structured text data including an analysis result, an estimated cause, and a recommended action. For example, an output of the present large language model is a score value from 1 to 10 indicating a maintenance priority for a specific robot. As another example, an output of the present large language model is data in a configuration file format including a specific parameter set for line reconfiguration. The present system inputs the output text data to a parser. The present parser extracts an executable command and parameter from the text data. The present system transmits the extracted command to a control interface of each device. The present system eliminates a conventional process in which a human manually creates a prompt, and dynamically generates a prompt based on a data state inside the system. The present system stabilizes inference accuracy of the large language model by this unconventional processing method. The present system brings about a technical effect of preventing useless consumption of calculation resources and reducing processing latency by automation of prompt engineering. The present system realizes highly advanced autonomous control in an application field such as operation management of an autonomous factory and power grid control of a smart grid.

As described above, the system of the present invention centrally manages operation data and failure histories of various automated devices and peripheral devices in a factory, realizes trend analysis, automatic response, and optimization proposal using a generative AI, and enables an improvement in an operation rate of an entire factory, minimization of downtime, reduction of maintenance costs, and realization of a flexible production system. Specifically, the present system constructs an integrated data pipeline for eliminating data silos in a heterogeneous environment. The present system converts data in various formats asynchronously transmitted from each device into a normalized data vector having a common schema. The present system stores the normalized data vector in a distributed in-memory database. The present system executes a plurality of machine learning models in parallel on this distributed in-memory database. The present system processes a huge amount of matrix operations at high speed by utilizing a parallel computing cluster using graphics processing units. The present system connects an anomaly detection model, a time-series prediction model, and a large language model in a pipeline manner. The present system directly passes an output tensor of a preceding model as an input tensor of a succeeding model. For example, initial input data to the present pipeline is tens of thousands of dimensions of streaming data sampled at a one-second cycle from all sensors in the factory. As another example, the input data to the present pipeline is a time-series array of environmental temperature and humidity acquired from an external weather information server. A final output of the present pipeline is a multidimensional control vector for optimizing control parameters of the entire factory. For example, the output of the present pipeline is a numerical data group specifying an upper limit value of an operation speed of each robot, a rotation speed of a cooling fan, and a conveyance speed of a conveyor. As another example, the output of the present pipeline is matrix data indicating an optimal solution for personnel allocation in a next production shift. The present system feeds back the output control vector to a programmable logic controller of each device. The present system always maintains an operating state of the factory in an optimal state by this closed-loop control. The present system realizes not merely business efficiency improvement but improvement of computer technology itself, which is optimization of data traffic on a computer network, leveling of a calculation load of a processor, and improvement of access efficiency of a storage. The present system exhibits a technical effect of dramatically enhancing robustness and scalability of the entire system by these technical improvements. The present system functions as a core control platform in realization of a smart factory advocated by Industry 4.0. The present system demonstrates its true value in application fields requiring extremely high quality control and traceability, such as manufacturing of aircraft parts and continuous production of pharmaceuticals. The present system also includes a fallback mechanism that calculates a reliability score for an inference result of a model and delegates a determination to a human operator when the score is low. The present system thereby reduces a risk of full automation and guarantees safe and reliable system operation.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

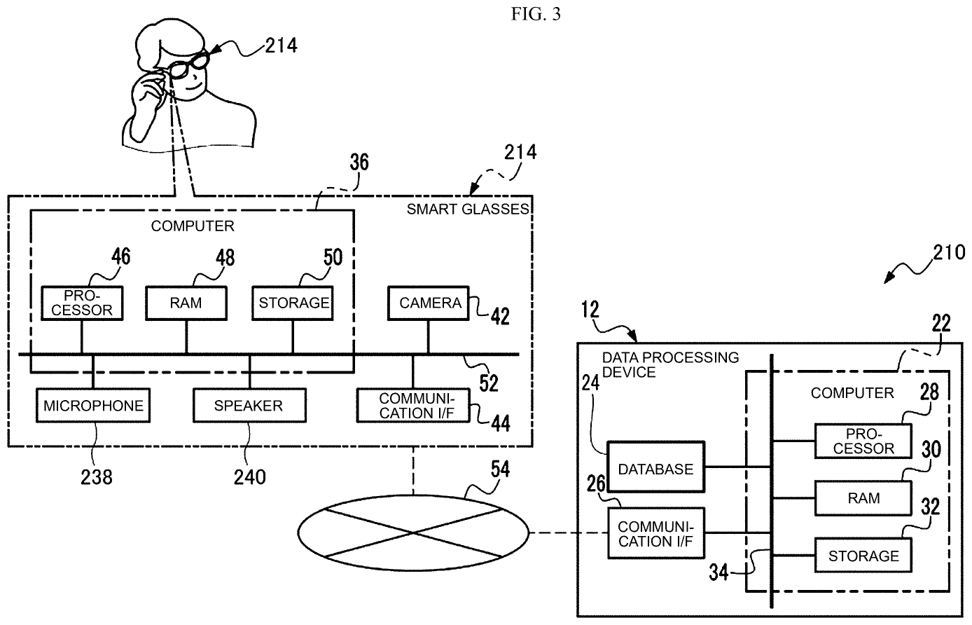

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

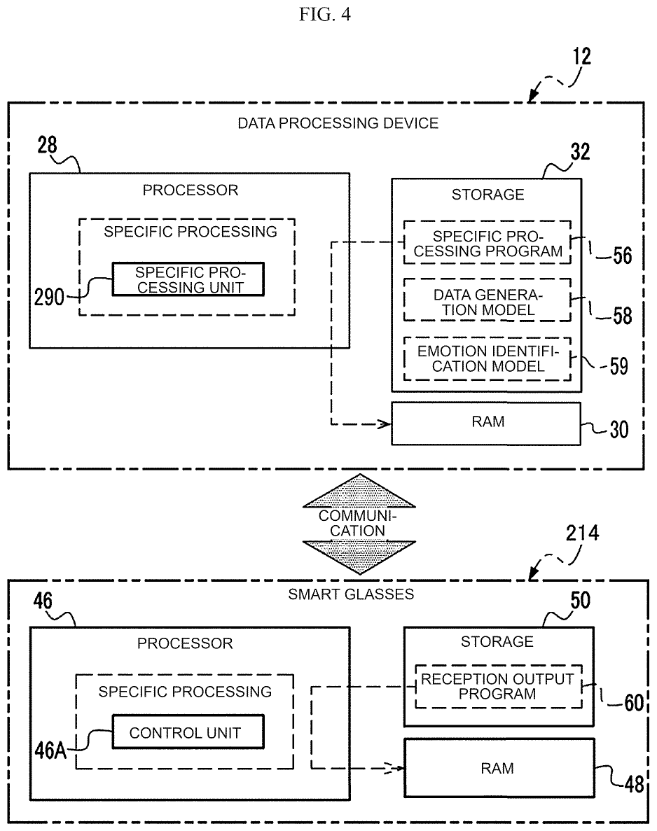

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### (Example 1)

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

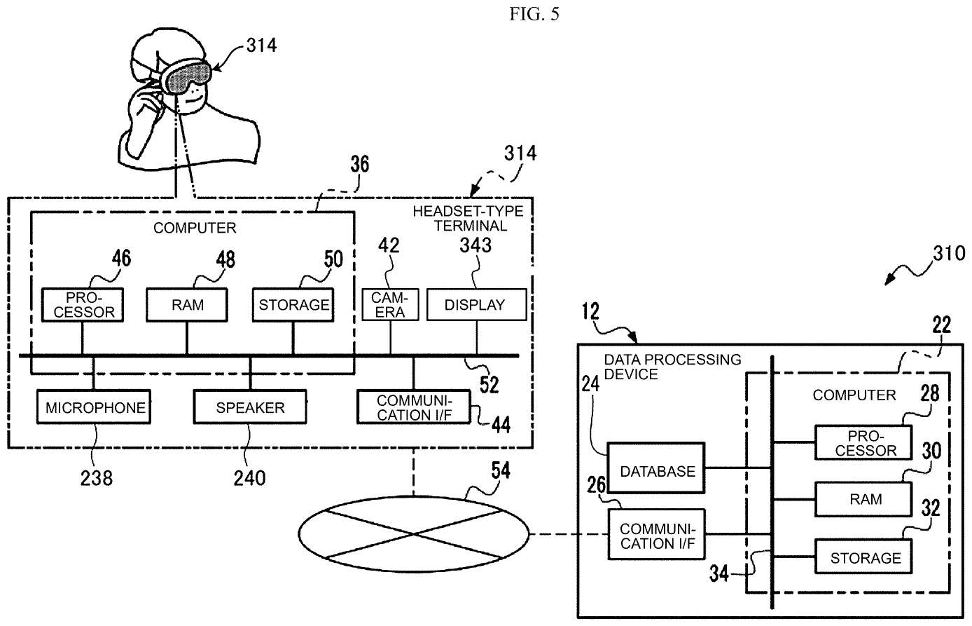

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

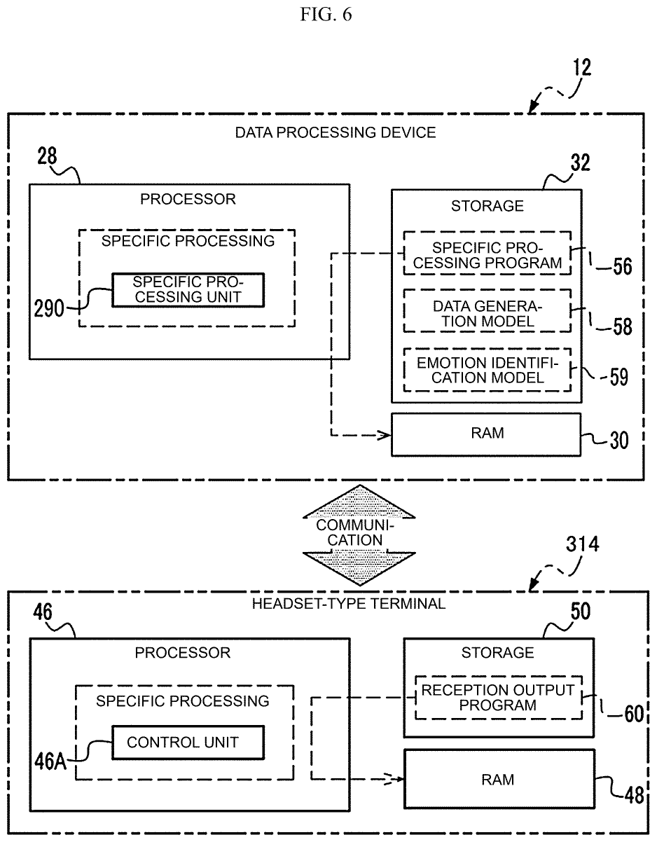

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

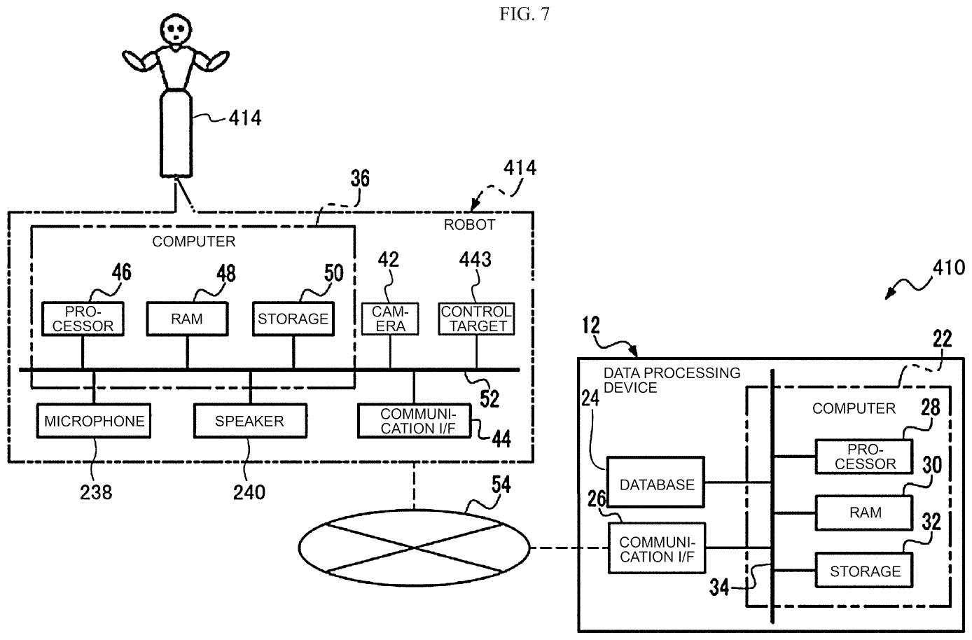

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

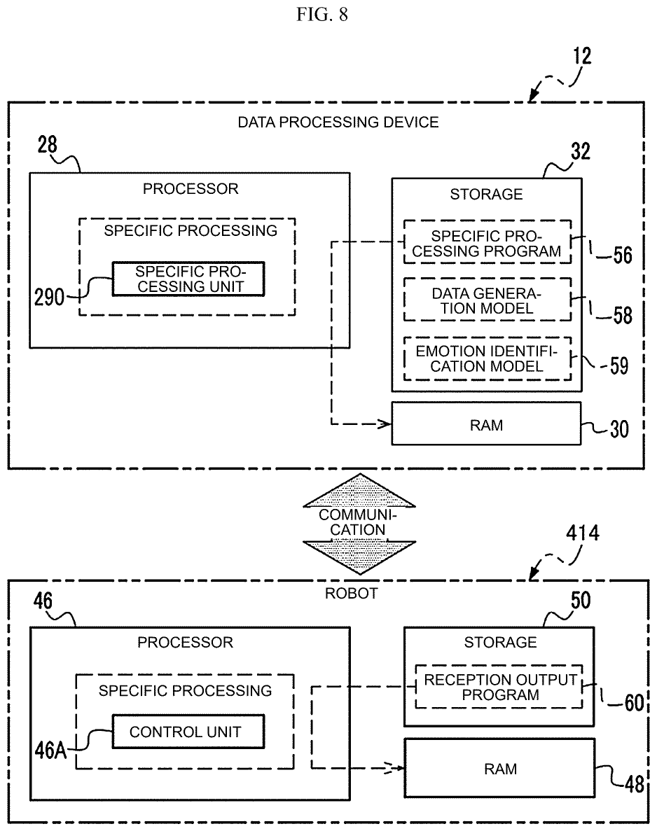

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

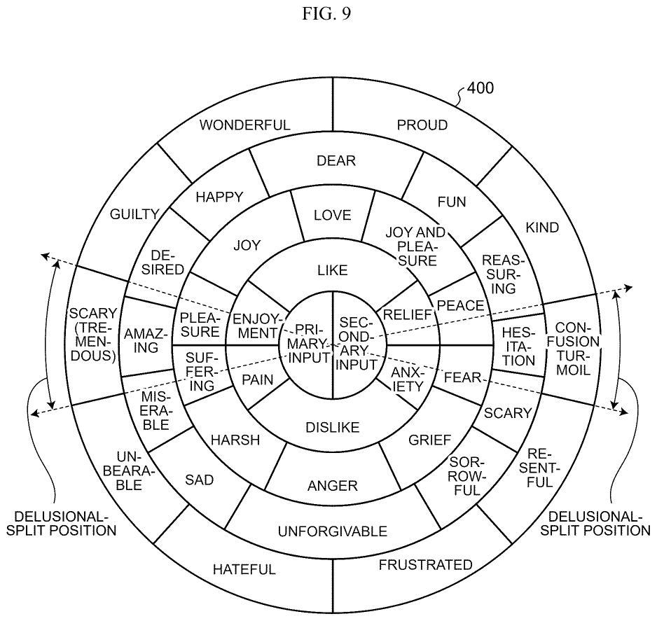

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

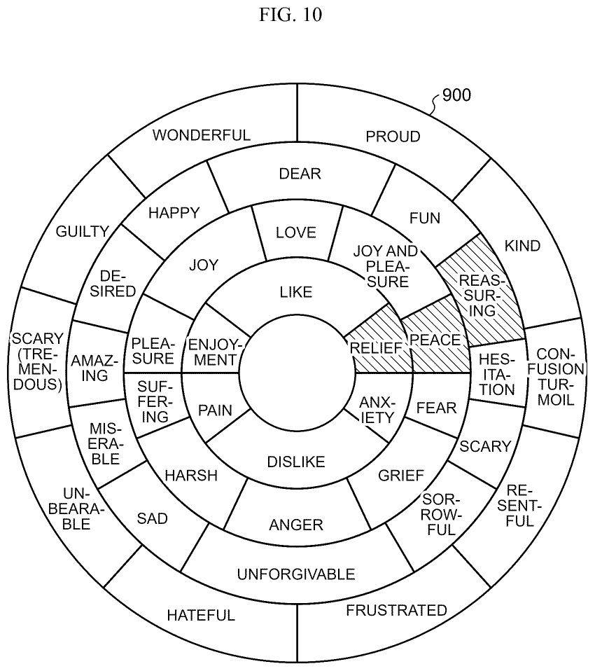

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A system comprising: a factory robot information management unit; a log collection unit; and a trend analysis and response unit, wherein the factory robot information management unit centrally manages identification information, an installation location, administrator information, a serial number, a firmware version, an installation date, a warranty period, maintenance contract information, a configuration change history, a failure response history, a part replacement history, maintenance department contact information, a sensor data type, and operating state information of various automated devices such as a welding robot, a painting robot, an assembly robot, a transfer robot, an inspection robot, a palletizing robot, and a collaborative robot, and peripheral devices thereof; the log collection unit automatically collects operation logs and failure occurrence logs such as a motor temperature, a current value, a vibration value, the number of operation cycles, an error code, a sensor value, a work completion time, a part wear degree, a quality determination result, and an abnormal event from each device managed by the factory robot information management unit in real time or periodically, and performs log normalization, format conversion, noise removal, importance determination, and extraction of logs before and after a failure occurrence; and the trend analysis and response unit analyzes collected time-series data and event logs in multiple dimensions using a generative AI, learns a past failure occurrence pattern and a normal operation pattern, extracts a complex abnormal pattern and a sign of failure occurrence by comparing with current log data, automatically notifies a maintenance department of a detailed log, an estimated cause, and a recommended countermeasure of a corresponding device when a failure or an abnormality is detected, simultaneously proposes a line stop and a production plan change to a production management department as necessary, and further automatically proposes an optimal production schedule and a line reconfiguration plan to an administrator by analyzing an operation status and a failure trend of all devices.

### Supplementary Note 2

The system according to Supplementary Note 1, further comprising a function of: analyzing detailed time-series data such as a motor temperature, a vibration value, an error code, a sensor value, a part wear degree, the number of work cycles, and a quality determination result of each robot and peripheral device using the generative AI; extracting a complex abnormal pattern and a sign of failure occurrence that are difficult to detect by conventional threshold monitoring, such as simultaneous occurrence of a gradual rise in motor temperature and an increase in vibration value, frequent occurrence of error codes, an abnormal trend of sensor values, and simultaneous multiple errors in a plurality of devices; and automatically generating an estimated failure cause and a recommended countermeasure based on an extraction result to notify the maintenance department and the production management department.

### Supplementary Note 3

The system according to Supplementary Note 1, further comprising a function of: comprehensively analyzing operation logs and failure trends of all robots and peripheral devices using the generative AI; and supporting an improvement in an operation rate of an entire factory, minimization of downtime, reduction of maintenance costs, and realization of a flexible production system, such as automatic extraction of a list of robots requiring maintenance within this week, identification of a process that is a production bottleneck, selection of a device for which preventive maintenance should be prioritized, and automatic proposal of a production efficiency maximization plan by line reconfiguration.

What is claimed is:

1. A system comprising:
circuitry configured to:
receive, via a communication interface coupled to a packet-switched network, operation log data and failure occurrence log data from a plurality of physical devices, and store the operation log data and failure occurrence log data in a storage device associated with device identifier records comprising device type, firmware version, and maintenance history data;
apply a time-series anomaly detection model to the operation log data to extract failure trend indicators and anomaly sign patterns for each device identifier, compute a predicted failure probability score for each device identifier, and generate an alert data record when the predicted failure probability score exceeds a failure threshold parameter;
apply a generative neural network model to the alert data record and the failure occurrence log data to generate a failure analysis report comprising a root cause candidate sequence, a recommended response action sequence, and a vendor contact data record; and
transmit the alert data record and the failure analysis report to terminal devices via the communication interface, and transmit automated contact request data to external service endpoint systems.

2. The system according to claim 1, wherein the circuitry is configured to receive operation log data at configurable collection intervals via the communication interface from physical devices managed in the device identifier records, parse each log record to extract numerical parameter values, categorical state identifiers, and timestamp values, and store the parsed log records in a time-series database in the storage device indexed by device identifier.

3. The system according to claim 2, wherein the circuitry is configured to apply a one-dimensional convolutional neural network to time-series log parameter arrays to extract feature vectors, and apply a long short-term memory network to the extracted feature vectors to generate multi-step ahead prediction values for each device identifier, computing the predicted failure probability score from the divergence between predicted values and observed log values.

4. The system according to claim 3, wherein the circuitry is configured to apply an autoencoder anomaly detection model pre-trained on operation log data records representing normal device operating conditions to incoming log parameter arrays, compute reconstruction error scores, and incorporate reconstruction error scores exceeding a reconstruction threshold parameter as additional failure trend indicators.

5. The system according to claim 1, wherein the circuitry is configured to apply the generative neural network model to historical failure occurrence log data and maintenance history records associated with the device identifier to identify recurring failure patterns, generate a root cause candidate sequence ranked by occurrence probability, and incorporate the ranked root cause candidate sequence in the failure analysis report.

6. The system according to claim 5, wherein the circuitry is configured to retrieve historical failure records from a vector database by cosine similarity search using a query embedding vector derived from the current failure occurrence log data, and incorporate the retrieved historical failure records as reference context in the generative neural network model prompt for root cause candidate sequence generation.

7. The system according to claim 1, wherein the circuitry is configured to apply a device dependency graph model to the device identifier records by constructing a dependency graph comprising device nodes and connection edges derived from device topology data, apply a graph neural network to execute message passing operations, and identify devices with high centrality scores as high-impact failure propagation nodes.

8. The system according to claim 7, wherein the circuitry is configured to generate a cascade failure risk record when a device with a high centrality score generates an alert data record, the cascade failure risk record comprising a list of downstream device identifiers connected to the failed device and a recommended isolation action sequence, and transmit the cascade failure risk record to terminal devices associated with administrative user identifiers.

9. The system according to claim 1, wherein the circuitry is configured to generate the vendor contact data record by applying the generative neural network model to the failure analysis report and maintenance contract data records associated with the device identifier to extract vendor identifier, failure code, and urgency parameter fields, and format the vendor contact data record as a structured message for automated transmission.

10. The system according to claim 9, wherein the circuitry is configured to transmit the vendor contact data record to a vendor service endpoint system via the communication interface, receive an acknowledgment response comprising a service ticket identifier, store the service ticket identifier in the device identifier record, and update the failure occurrence log data with the service ticket identifier and submission timestamp.

11. The system according to claim 1, wherein the circuitry is configured to aggregate failure trend indicators and anomaly sign patterns across all device identifiers to compute a portfolio-level failure risk score, generate a trend analysis summary report from the aggregated data using the generative neural network model, and transmit the trend analysis summary report to terminal devices associated with operational management user identifiers.

12. The system according to claim 1, wherein the circuitry is configured to monitor device configuration change records comprising firmware update histories, software version histories, and hardware replacement histories for each device identifier, compute a configuration change correlation score between recent configuration changes and subsequent failure events, and incorporate high-correlation configuration change records as contextual features in the failure analysis report.

13. The system according to claim 1, wherein the circuitry is configured to update the time-series anomaly detection model by generating training pairs from historical operation log data records and corresponding validated failure event labels, and fine-tune the model to improve failure prediction accuracy for specific device type patterns.

14. The system according to claim 1, wherein the circuitry is configured to generate a preventive maintenance schedule data record for each device identifier by applying the generative neural network model to the predicted failure probability score trajectory, historical maintenance history records, and maintenance contract data, and transmit the preventive maintenance schedule data record to terminal devices associated with maintenance management user identifiers.

15. The system according to claim 14, wherein the circuitry is configured to compute an optimal maintenance scheduling sequence across all device identifiers by applying a scheduling optimization model that minimizes total predicted downtime while satisfying maintenance resource capacity constraints, and generate a consolidated maintenance calendar data record from the optimized scheduling sequence.

16. The system according to claim 1, wherein the circuitry is configured to store all alert data records, failure analysis reports, vendor contact records, and response completion records in an audit log data structure with timestamps, and generate a response performance report from the audit log data structure measuring mean time to detection and mean time to resolution metrics.

17. The system according to claim 1, wherein the physical devices comprise automated equipment and associated peripheral monitoring sensor devices in a manufacturing facility, the operation log data comprises parameter telemetry from device sensors, and the device identifier records include maintenance contract data and failure response history for each device.

18. A system comprising:
circuitry configured to:
receive, via a communication interface coupled to a packet-switched network, operation log data from a plurality of physical devices and store the data with device identifier records in a storage device;
apply a one-dimensional convolutional neural network and a long short-term memory network to time-series log arrays to generate predicted failure probability scores, and apply an autoencoder anomaly detection model to compute reconstruction error scores;
apply a generative neural network model to failure occurrence log data to generate failure analysis reports comprising root cause candidate sequences retrieved by cosine similarity from a vector database;
apply a device dependency graph model using a graph neural network to identify high-impact failure propagation nodes and generate cascade failure risk records; and
transmit alert data records and failure analysis reports to terminal devices, and automated contact data to external service endpoints.

19. The system according to claim 18, wherein the circuitry is configured to aggregate failure trend indicators across all device identifiers to compute a portfolio-level failure risk score, generate a trend analysis summary report using the generative neural network model, and generate a consolidated maintenance calendar data record by applying a scheduling optimization model that minimizes total predicted downtime while satisfying maintenance resource capacity constraints.

20. A method comprising:
receiving, via a communication interface coupled to a packet-switched network, operation log data and failure occurrence log data from a plurality of physical devices, and storing the data in a storage device associated with device identifier records;
applying a time-series anomaly detection model to extract failure trend indicators and compute predicted failure probability scores for each device identifier, and generating an alert data record when the predicted failure probability score exceeds a threshold;
applying a generative neural network model to generate a failure analysis report comprising a root cause candidate sequence and a recommended response action sequence;
transmitting the alert data record and failure analysis report to terminal devices via the communication interface, and transmitting automated contact request data to external service endpoint systems.
